(19) United States
(12) Patent Application Publication
(10) Pub. No.: US 2025/0251890 A1
(43) Pub. Date: Aug. 7, 2025

(54) REMOTE CONTROL APPARATUS AND REMOTE MANIPULATION SYSTEM

(71) Applicant: Kubota Corporation, Osaka (JP)

(72) Inventors: Chiaki KOMARU, Sakai-shi (JP); Yushi MATSUZAKI, Sakai-shi (JP)

(21) Appl. No.: 19/189,556

(22) Filed: Apr. 25, 2025

Related U.S. Application Data
(63) Continuation of application No. PCT/JP2023/046839, filed on Dec. 27, 2023.

(30) Foreign Application Priority Data
Dec. 28, 2022 (JP) 2022-211308

(51) Int. Cl. G06F 3/14; A01B 69/00; G05D 1/224; G05D 1/246; G05D 1/648; G05D 107/20; H04N 7/18

(52) U.S. Cl. CPC G06F 3/14; A01B 69/007; G05D 1/2247; G05D 1/2469; G05D 1/648; H04N 7/183; G05D 2107/21

(57) ABSTRACT

A remote control apparatus includes a manipulator to manipulate a working vehicle remotely, a communication module configured or programmed to receive traveling information that indicates a speed or an acceleration of the working vehicle, a display, and a controller configured or programmed to cause the display to perform highlighted display that changes in accordance with the traveling information when the working vehicle is driven remotely by using the manipulator.

### CROSS REFERENCE TO RELATED APPLICATIONS

This application is a continuation application of International Application No. PCT/JP2023/046839, filed on Dec. 27, 2023, which claims the benefit of priority to Japanese Patent Application No. 2022-211308, filed on Dec. 28, 2022. The entire contents of each of these applications are hereby incorporated herein by reference.

### BACKGROUND OF THE INVENTION

### 1. Field of the Invention

The present invention relates to remote control apparatuses for manipulating working vehicles remotely, and remote manipulation systems for manipulating working vehicles remotely.

### 2. Description of the Related Art

For example, Japanese Unexamined Patent Application Publication No. 2020-97270 discloses a driving support system that includes an anger determining unit that determines anger of a driver, an acceleration control unit that controls acceleration in relation to an operation amount of an accelerator pedal based on a determined result of the anger determining unit, and a physically-perceived-speed varying unit that increases a physically-perceived speed based on the determined result of the anger determining unit. Since this driving support system performs display that increases the speed perceived physically by the driver upon detecting that the driver is angry, it is possible to make the driver aware of not being in a normal cool and calm state of mind because of the anger and thus help the driver return to the driver's normal self quickly.

### SUMMARY OF THE INVENTION

Unlike general vehicles, the speed range of industrial machines is biased to a low-speed range. Therefore, it is less easy to perceive a change in vehicle speed physically. Remote driving makes it more difficult to feel a vehicle speed by physical perception. What makes matters even more difficult is the lack of markings such as a center line and poorness in changes in ambient scenery, which makes the vehicle speed harder to feel by physical perception when the vehicle is traveling on a pastureland, a field, or the like.

In light of the above problem, example embodiments of the present invention provide remote control apparatuses and remote manipulation systems that make it possible to assist remote manipulation.

Example embodiments of the present invention may include the following features.

A remote control apparatus according to an example embodiment of the present invention includes a manipulator to manipulate a working vehicle remotely, a communication module configured or programmed to receive traveling information that indicates a speed or an acceleration of the working vehicle, a display, and a controller configured or programmed to cause the display to perform highlighted display that changes in accordance with the traveling information when the working vehicle is driven remotely via the manipulator.

The highlighted display may change in accordance with the traveling information and be performed in an emphasized manner as compared to a manner in which the working vehicle is actually traveling.

The highlighted display may change in accordance with the traveling information and give an impression that the working vehicle is traveling in a state equal to or greater than an actual state in which the working vehicle is actually traveling.

The highlighted display may change in accordance with the traveling information and give an impression that the working vehicle is traveling at a speed or acceleration greater than an actual speed or acceleration of the working vehicle.

The communication module may be configured or programmed to receive captured images one after another when the working vehicle is driven remotely, the captured images being obtained by performing imaging in a traveling direction of the working vehicle, the display may display the captured images on a remote driving screen one after another, and the controller may be configured or programmed to command that the highlighted display be performed on the remote driving screen.

The display may perform the highlighted display on another portion of the remote driving screen in addition to or instead of a portion of the remote driving screen that displays a value or degree of an actual speed or acceleration of the working vehicle.

The controller may be configured or programmed to command that the highlighted display be performed on the remote driving screen when a first condition is met, and command that the highlighted display be not performed on the remote driving screen when the first condition is not met.

The controller may be configured or programmed to determine that the first condition is met in a case where an amount of change between a plurality of the captured images is less than a threshold value, and determine that the first condition is not met in a case where the amount of change between the plurality of the captured images is not less than the threshold value.

The controller may be configured or programmed to determine that the first condition is met in a case where no road-surface marking is included in the captured image, and determine that the first condition is not met in a case where a road-surface marking is included in the captured image.

The controller may be configured or programmed to use position information of the working vehicle and map information to determine that the first condition is met if a current position indicated by the position information of the working vehicle is within a predetermined area on a map indicated by the map information, and determine that the first condition is not met if the current position indicated by the position information of the working vehicle is not within the predetermined area.

The controller may be configured or programmed to command that the highlighted display be performed in a superimposed manner on the captured image on the remote driving screen.

The controller may be configured or programmed to command that the highlighted display be performed on a peripheral portion of the remote driving screen or a peripheral portion of the captured image.

The controller may be configured or programmed to command that a moving speed of a sign be changed in accordance with the speed or the acceleration of the working vehicle.

The controller may be configured or programmed to command that a mode of a sign be changed in accordance with the speed or the acceleration of the working vehicle.

The sign may extend in the traveling direction of the working vehicle.

The sign may include a plurality of virtual signs arranged in the traveling direction of the working vehicle.

The controller may be configured or programmed to command that a region of the peripheral portion be changed in accordance with the speed or the acceleration of the working vehicle.

The controller may be configured or programmed to, as the highlighted display, command that a color of a particular portion other than the captured image of the remote driving screen be varied in accordance with the speed or the acceleration of the working vehicle.

The controller may be configured or programmed to, as the highlighted display, command that a color of a frame of the remote driving screen be varied in accordance with the speed or the acceleration of the working vehicle.

The remote driving screen may include a forward captured image and a rearward captured image, and the controller may be configured or programmed to command that the highlighted display be performed on the forward captured image at a time of forward traveling and on the rearward captured image at a time of rearward traveling.

The controller may be configured or programmed to, when the working vehicle is traveling rearward, command that an image captured at a time of rearward traveling of the working vehicle be displayed on the remote driving screen, and command that, as the highlighted display, a mode of a guide line displayed on the remote driving screen be varied in accordance with the speed or the acceleration of the working vehicle.

The controller may be configured or programmed to, when the working vehicle is accelerating, command that a range that is displayed as the captured image on the remote driving screen be shifted up in accordance with a change in acceleration, and when the working vehicle is decelerating, command that the range that is displayed as the captured image on the remote driving screen be shifted down in accordance with a change in acceleration.

The controller may be configured or programmed to, when the working vehicle is being steered leftward, command that a range that is displayed as the captured image on the remote driving screen be shifted to the right in accordance with a leftward steering angle, and when the working vehicle is being steered rightward, command that the range that is displayed as the captured image on the remote driving screen be shifted to the left in accordance with a rightward steering angle.

A remote manipulation system according to another example embodiment of the present invention includes a working vehicle, and the remote control apparatus described above. The working vehicle includes a detector to detect the speed or the acceleration of the working vehicle, an imager to perform imaging in a traveling direction of the working vehicle, and a vehicle-mounted communication module configured or programmed to transmit correspondence data in which the traveling information that indicates the speed or the acceleration detected by the detector and a captured image obtained by the imager are associated to correspond to each other, and the communication module of the remote control apparatus is configured or programmed to receive the correspondence data transmitted from the vehicle-mounted communication module.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a diagram illustrating a configuration of a remote manipulation system according to an example embodiment of the present invention;

FIG. 2 is a side view of a tractor, which is an example of a working vehicle 1.

FIG. 3 is a diagram illustrating an example of correspondence data.

FIG. 4 is a diagram illustrating an example of a planned traveling route L.

FIG. 5A is a diagram illustrating an example of a remote driving screen G2 without highlighted display K.

FIG. 5B is a diagram illustrating an example of a remote driving screen G2 with highlighted display K.

FIG. 5C is a diagram illustrating highlighted display K of a second display mode on the remote driving screen G2.

FIG. 6 is a diagram illustrating highlighted display K of a third display mode on the remote driving screen G2.

FIG. 7A is a diagram illustrating highlighted display K of a fourth display mode on the remote driving screen G2.

FIG. 7B is a diagram illustrating highlighted display K of the fourth display mode on the remote driving screen G2.

FIG. 8A is a diagram illustrating highlighted display K of a fifth display mode on the remote driving screen G2.

FIG. 8B is a diagram illustrating highlighted display K of a seventh display mode on the remote driving screen G2.

FIG. 8C is a diagram illustrating highlighted display K of an eighth display mode on the remote driving screen G2.

FIG. 9A is a diagram illustrating an example of a selection screen G1 on a display 34.

FIG. 9B is a diagram illustrating an example of the selection screen G1 on the display 34.

FIG. 9C is a diagram illustrating an example of the selection screen G1 on the display 34.

FIG. 9D is a diagram illustrating an example of the selection screen G1 according to a first modification of an example embodiment of the present invention on the display 34.

FIG. 10A is a flowchart illustrating the operation of the working vehicle 1 under remote driving.

FIG. 10B is a flowchart illustrating the operation of a remote control apparatus 30 when the working vehicle 1 is manipulated remotely.

FIG. 11 is a flowchart illustrating screen display update processing.

FIG. 12A is a diagram illustrating an example of the remote driving screen G2 according to the first modification of an example embodiment of the present invention.

FIG. 12B is a diagram illustrating highlighted display K on the remote driving screen G2 according to the first modification of an example embodiment of the present invention.

FIG. 12C is a diagram illustrating highlighted display K on the remote driving screen G2 according to the first modification of an example embodiment of the present invention.

FIG. 12D is a diagram illustrating highlighted display K on the remote driving screen G2 according to the first modification of an example embodiment of the present invention.

FIG. 12E is a diagram illustrating highlighted display K on the remote driving screen G2 according to the first modification of an example embodiment of the present invention.

FIG. 13 is a flowchart illustrating screen display update processing according to a second modification of an example embodiment of the present invention.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

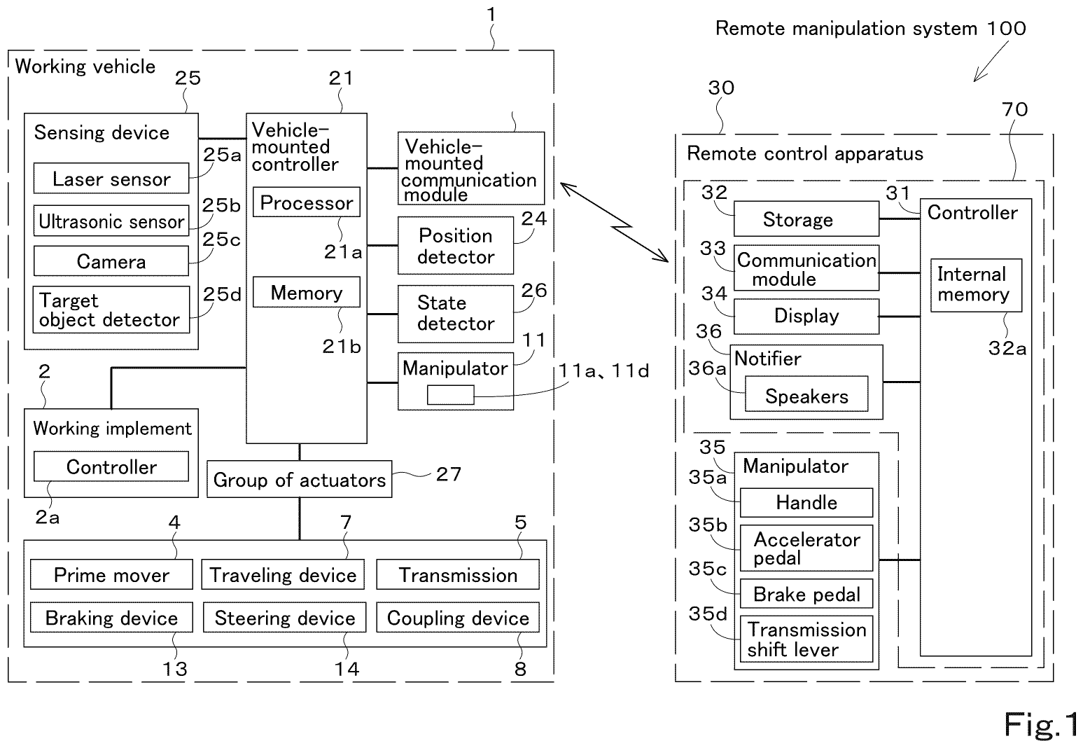

FIG. 1 is a diagram illustrating a configuration of a remote manipulation system 100 according to an example embodiment of the present invention. The remote manipulation system 100 includes a working vehicle 1 and a remote control apparatus 30. The remote manipulation system 100 and the remote control apparatus 30 enable remote manipulation (or remote operation) of the working vehicle 1 and remote monitoring of the working vehicle 1. The working vehicle 1 is a farm machine that can be operated remotely (for example, remote traveling, remote work, etc.) by the remote control apparatus 30 (referred to also as “remote-manipulation farm machine”). For example, the working vehicle 1 is a tractor. A tractor is an example of a farm machine that performs agricultural work on an agricultural field. The working vehicle 1 may be a farm machine that is not a tractor, e.g., a construction machine, or a working machine.

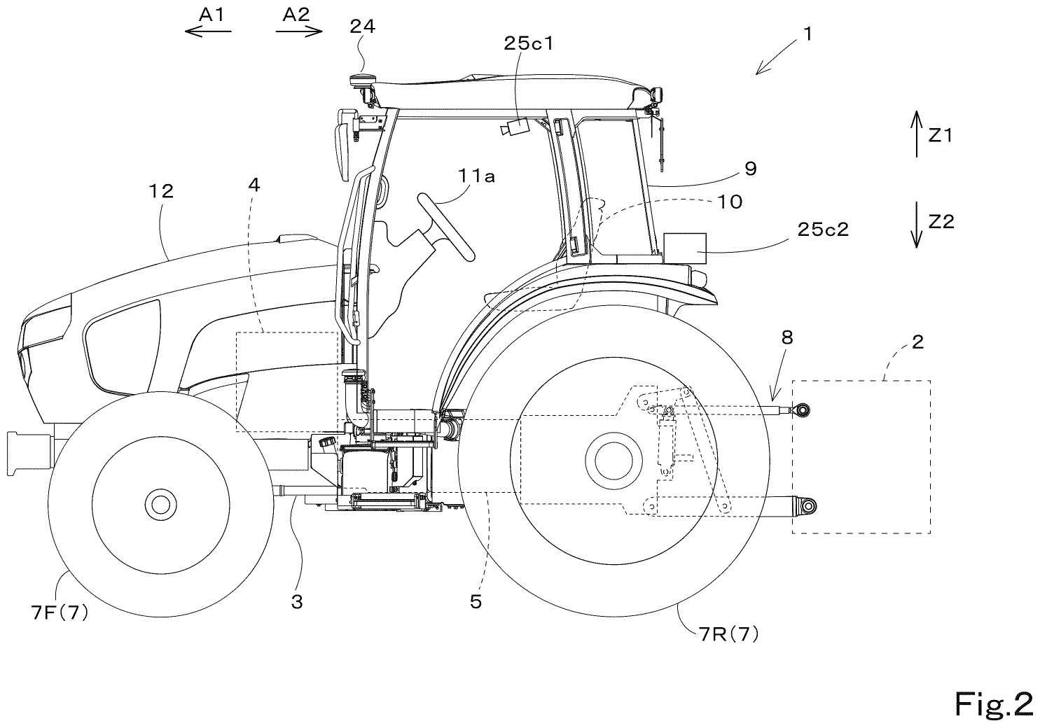

FIG. 2 is a side view of a tractor, which is an example of the working vehicle 1. The working vehicle 1 includes a vehicle body 3. A traveling device 7 is provided on the vehicle body 3. The traveling device 7 includes front wheels 7F and rear wheels 7R provided on the left side and the right side of the vehicle body 3 respectively and supports the vehicle body 3 to make it travelable. The traveling device 7 may be a crawler device.

A prime mover 4, a transmission 5, a braking device 13 (FIG. 1), and a steering device 14 (FIG. 1) are mounted on the vehicle body 3. The prime mover 4 is an engine (a diesel engine, a gasoline engine), an electric motor, or the like. The transmission 5 switches a propelling force of the traveling device 7 by performing transmission operation, for example, and switches the traveling device 7 between forward traveling and rearward traveling. The braking device 13 performs braking on the vehicle body 3. The steering device 14 performs steering of the vehicle body 3.

A cabin 9, which is an example of a protection mechanism, is provided on the top of the vehicle body 3. A n operator's seat 10 and a manipulator 11 are provided inside the cabin 9. The working vehicle 1 is a tractor capable of performing unmanned traveling (driving) to perform work via a working implement 2. A n operator who is seated on the operator's seat 10 is able to, by manipulating the manipulator 11, cause the working vehicle 1 to travel and perform work via the working implement 2. The cabin 9 provides protection to the operator's seat 10 by enclosing the front, the rear, the top, the left side, and the right side of the operator's seat 10. The protection mechanism is not limited to the cabin 9. The protection mechanism may be a ROPS or the like.

The direction indicated by an arrow A1 in FIG. 2 is a forward direction of the working vehicle 1. The direction indicated by an arrow A2 is a rearward direction of the working vehicle 1. The direction indicated by an arrow Z1 is a top direction of the working vehicle 1. The direction indicated by an arrow Z2 is a bottom direction of the working vehicle 1. The direction orthogonal to the arrows A1, A2, Z1, and Z2 is a width direction (horizontal direction) of the working vehicle 1. The near side in FIG. 2 is the left side with respect to the working vehicle 1. The far side in FIG. 2 is the right side with respect to the working vehicle 1.

A coupling device 8 is provided on a rear portion of the vehicle body 3. The coupling device 8 is a three-point linkage or the like. The working implement 2 (an implement, etc.) can be detachably attached to the coupling device 8. The working vehicle 1 (the vehicle body 3) is capable of towing the working implement 2 by traveling due to the driving of the traveling device 7, with the working implement 2 attached to the coupling device 8. The coupling device 8 is capable of raising and lowering the working implement 2 and changing the attitude of the working implement 2.

The working implement 2 is, for example, a cultivator for cultivation, a fertilizer spreader for spreading a fertilizer, an agricultural chemical spreader for spreading an agricultural chemical, a harvester for harvesting crops, a mower for cutting grass and the like, a tedder for spreading out grass and the like, a rake for collecting grass and the like, or a baler for baling grass and the like. Each of these devices can be detachably coupled to the working vehicle 1 by the coupling device 8. The working vehicle 1 performs agricultural work on an agricultural field via the working implement 2.

A hood 12 is provided in front of the cabin 9. The hood 12 is mounted over the vehicle body 3. A housing space is provided between the hood 12 and the vehicle body 3. Not only the prime mover 4 but also a cooling fan, a radiator, a battery, and the like are housed in the housing space.

As illustrated in FIG. 1, the working vehicle 1 includes a vehicle-mounted controller 21, a vehicle-mounted communication module 23, a position detector 24, a sensing device 25, a state detector 26, the manipulator 11, a group of actuators 27, the prime mover 4, the traveling device 7, the transmission 5, the braking device 13, the steering device 14, and the coupling device 8. A n in-vehicle network such as CAN, LIN, or FlexRay is built on the working vehicle 1. The vehicle-mounted communication module 23, the position detector 24, the sensing device 25, the state detector 26, the manipulator 11, the group of actuators 27, the working implement 2 coupled to the working vehicle 1, and the like, are electrically connected to the vehicle-mounted controller 21 via the in-vehicle network.

The vehicle-mounted controller 21 is an ECU (Electric Control U nit) that includes a processor 21a and a memory 21b. The vehicle-mounted controller 21 is a controller configured or programmed to control the operation of each component of the working vehicle 1. The memory 21b is a volatile memory, a non-volatile memory, or the like. Various kinds of information and data to be used by the vehicle-mounted controller 21 to control the operation of each component of the working vehicle 1 are stored in a readable-and-writeable manner in the memory 21b of the vehicle-mounted controller 21.

The vehicle-mounted communication module 23 includes an antenna for wireless communication via a cellular phone communication network or via the Internet or via a wireless LA N, and includes ICs (integrated circuits) and electric circuits and the like. The vehicle-mounted controller 21 communicates with the remote control apparatus 30 wirelessly via the vehicle-mounted communication module 23.

Although an example in which the working vehicle 1 and the remote control apparatus 30 communicate with each other via a cellular phone communication network, etc., is disclosed in the present example embodiment, instead, for example, the working vehicle 1 and the remote control apparatus 30 may be configured to be communication-connected to a cellular phone communication network, etc., via an external device such as a server or a relay device. As another example, the working vehicle 1 and the remote control apparatus 30 may be configured to communicate with each other directly by using a near field communication signal such as a BLE (Bluetooth (Registered trademark) Low Energy) signal or a UHF (Ultra High Frequency) signal. In this case, such communication can be achieved by providing an interface for near field communication in each of the vehicle-mounted communication module 23 and the remote control apparatus 30.

The position detector 24 is, for example, provided on the top of the cabin 9 (FIG. 2). The position where the position detector 24 is provided is not limited to the top of the cabin 9. The position detector 24 may be provided at any other position over the vehicle body 3 or at a predetermined position on the working implement 2. The position detector 24 detects its own position (measured position information including latitude and longitude) by using a satellite positioning system. That is, the position detector 24 receives signals (positions of positioning satellites, transmission times, correction information, etc.) transmitted from the positioning satellites and detects its own position based on the signals. The position detector 24 may detect, as its own position, a position corrected based on a signal such as a correction signal from a base station (reference station) capable of receiving signals from the positioning satellites.

The position detector 24 may include an inertial measurement unit such as a gyroscope sensor or an acceleration sensor. In this case, the position detector 24 may, via the inertial measurement unit, correct the position (latitude and longitude) detected based on signals received from the positioning satellites, and detect the position after the correction as its own position. The position detector 24 regards the detected own position as the position of the working vehicle 1. The position detector 24 may calculate the position of the working vehicle 1 based on the detected own position and pre-stored external-shape information about the working vehicle 1. The position detector 24 may calculate the position of the working implement 2 based on the detected own position, pre-stored external-shape information about the working implement 2, and the attachment position of the working implement 2 attached to the vehicle body 3.

The sensing device 25 performs sensing (monitoring) of a near area around the working vehicle 1. M ore particularly, the sensing device 25 includes laser sensor(s) 25a, ultrasonic sensor(s) 25b, camera(s) 25c, and a target object detector 25d. For example, a plurality of laser sensors 25a and a plurality of ultrasonic sensors 25b are provided. Each of the laser sensors 25a and the ultrasonic sensors 25b are provided at predetermined positions, for example, the front portion, the rear portion, the left side portion, and the right side portion, etc., of the working vehicle 1, and detect surrounding situations in front of, behind, to the left of, and to the right of the working vehicle 1, etc., and detect a target object that is present in the near area therearound. For example, the laser sensors 25a and the ultrasonic sensors 25b are provided at predetermined positions on the vehicle body 3 respectively such that even a target object that is located at a position that is within a predetermined target detection distance from the working vehicle 1 and is at a level lower than the position of the vehicle body 3 is detectable.

The laser sensors 25a and the ultrasonic sensors 25b provide an example of target object sensors. Either a plurality of laser sensors 25a or a plurality of ultrasonic sensors 25b, or both, may be provided as target object sensors in the sensing device 25. Any other kind of a plurality of target object sensors may be provided in the sensing device 25.

The laser sensor 25a is an optical sensor such as a LiDAR (Light Detecting And Ranging) sensor. The laser sensor 25a emits pulsed measurement light (laser light) millions of times per second from a light source such as a laser diode and scans the measurement light in a horizontal direction or a vertical direction by reflection via a rotatable mirror, thus performing light projection to a predetermined detection range (sensing range). Then, the laser sensor 25a receives, via its photo-reception element, reflection light coming back from the target object irradiated with the measurement light.

The target object detector 25d includes an electric circuit or an IC, etc., configured or programmed to detect whether a target object is present or absent, the position of the target object, and the type of the target object, etc., based on a received-light signal outputted from the photo-reception element of the laser sensor 25a. The target object detector 25d measures a distance to the target object based on time from emitting the measurement light to receiving the reflected light by the laser sensor 25a (TOF (Time of Flight) method). The target object that is detectable by the target object detector 25d includes the site where the working vehicle 1 travels and performs work, an agricultural field, crops on the agricultural field, ground, a road surface, any other object, a person, and the like.

The ultrasonic sensor 25b is an airborne ultrasound sensor such as a sonar. The ultrasonic sensor 25b transmits a measurement wave (ultrasound wave) to a predetermined detection range via a wave transmitter, and receives, via its wave receiver, a reflection wave coming back as a result of reflection of the measurement light by the target object. The target object detector 25d detects whether a target object is present or absent, the position of the target object, and the type of the target object, etc., based on a signal outputted from the wave receiver of the ultrasonic sensor 25b. The target object detector 25d measures a distance to the target object based on time from emitting the measurement wave to receiving the reflected wave by the ultrasonic sensor 25b (TOF method).

The camera 25c is a CCD camera with a built-in CCD (Charge Coupled Device) image sensor, a CMOS camera with a built-in CMOS (Complementary Metal Oxide Semiconductor) image sensor, or the like. Each camera 25c is installed at a predetermined position, for example, on the front portion, the rear portion, the left side portion, the right side portion, etc., of the working vehicle 1, and inside the cabin 9, as illustrated in FIG. 2. The camera 25c performs imaging of a near area in front of, behind, to the left of, to the right of the working vehicle 1, etc., and output data of a captured image. The camera 25c is an example of an imager.

For example, a plurality of cameras 25c is installed on the working vehicle 1. Among the plurality of cameras 25c installed on the working vehicle 1, an internal camera 25c1, which is installed inside the cabin 9 as illustrated in FIG. 2, performs imaging of a front area in front of the working vehicle 1 from the operator's seat 10. M ore particularly, the internal camera 25c1 performs imaging of a front area in front of the working vehicle 1 (in the traveling direction) with substantially the same field of view as that of the operator who is seated on the operator's seat 10. That is, a captured image of the traveling direction of the working vehicle 1 can be obtained by the internal camera 25c1.

Among the plurality of cameras 25c, a rear camera 25c2, which is installed behind the cabin 9 as illustrated in FIG. 2, performs imaging of a rear area behind the working vehicle 1. More particularly, for example, when a shift lever is operated to a rearward-traveling position, the rear camera 25c2 performs imaging of a rear area behind the working vehicle 1 (in the rearward-traveling direction) from behind the cabin 9. That is, a captured image of a rear area behind the working vehicle 1 (hereinafter may be referred to as “rearward captured image” where appropriate) is obtained by the rear camera 25c2. The rear camera 25c2 may be configured to always perform imaging of a rear area behind the working vehicle 1 regardless of the position of the shift lever (namely, its forward-traveling position, its neutral position, or its rearward-traveling position).

The target object detector 25d can also be configured to detect whether a target object is present or absent, the position of the target object, and the type of the target object, etc., based on data of a captured image outputted from the camera 25c.

The sensing device 25 performs sensing (monitoring) of surrounding situations around the working vehicle 1 and the working implement 2 via the laser sensors 25a, the ultrasonic sensors 25b, the cameras 25c, and the target object detector 25d, and outputs sensing information that indicates the results thereof to the vehicle-mounted controller 21. The sensing information includes at least detection information obtained by the target object detector 25d and data of images captured by the cameras 25c. Besides these kinds of information, detection information obtained by the laser sensors 25a and the ultrasonic sensors 25b may be included in the sensing information.

The state detector 26 detects the operation state of the working vehicle 1 and the operation state of the working implement 2. Specifically, various sensors that are provided on components of the working vehicle 1 and the working implement 2, and a processor, are included in the state detector 26. The processor is configured or programmed to detect (computes) the operation state of the working vehicle 1 and the operation state of the working implement 2 based on signals outputted from the various sensors. The state of the working vehicle 1 detected by the state detector 26 includes the drive/stop state of each component of the working vehicle 1, the traveling direction of the working vehicle 1, the traveling speed thereof, the acceleration thereof, the attitude thereof, and the like. The state of the working implement 2 detected by the state detector 26 includes the drive/stop state of each component of the working implement 2, the attitude thereof, and the like.

The state detector 26 may acquire, in a predetermined cycle, the position of the vehicle body 3 (the position of the working vehicle 1) detected by the position detector 24, and detect (calculate) the position of the working implement 2 based on the position of the vehicle body 3 and/or detect changes (transition) in the position of the vehicle body 3. The state detector 26 may detect the traveling speed of the vehicle body 3 based on the changes in the position of the vehicle body 3. As another example, a number-of-revolutions sensor configured to detect the number of rotations of the front/rear wheels 7F/7R of the traveling device 7 or detect the number of revolutions of a traveling motor that causes the front/rear wheels 7F/7R to rotate may be provided, and the state detector 26 may detect the traveling speed of the vehicle body 3 based on an output signal of the number-of-revolutions sensor. The state detector 26 may include a speedometer and acquire the traveling speed of the vehicle body 3 measured by the speedometer. The state detector 26 may detect the acceleration based on a change in speed per unit time. The state detector 26 may include an accelerometer and acquire the acceleration of the vehicle body 3 measured by the accelerometer.

The state detector 26 generates detection information that indicates the detected operation state of the working vehicle 1 and the working implement 2 and outputs the detection information to the vehicle-mounted controller 21. For example, the detection information generated by the state detector 26 includes manipulation information about the working vehicle 1 and the working implement 2. The manipulation information includes information about, for example, the speed of the working vehicle 1, the acceleration thereof, the transmission switching position of the transmission 5, the braking position of the braking device 13, and the operation position of the working implement 2.

The position detector 24 and the state detector 26 output the detection information that indicates the results of detection in a predetermined cycle or at a predetermined timing to the vehicle-mounted controller 21 on a timely basis. The sensing device 25 outputs sensing information that indicates the results of sensing in a predetermined cycle or at a predetermined timing to the vehicle-mounted controller 21 on a timely basis. The vehicle-mounted controller 21 causes its internal memory 21b to store the detection information inputted from the position detector 24 and the state detector 26 and the sensing information inputted from the sensing device 25. When remote driving is being performed, the vehicle-mounted controller 21 transmits pieces of the detection information and the sensing information that are stored in the internal memory 21b to the remote control apparatus 30 one after another in a predetermined cycle or at a predetermined timing via the vehicle-mounted communication module 23.

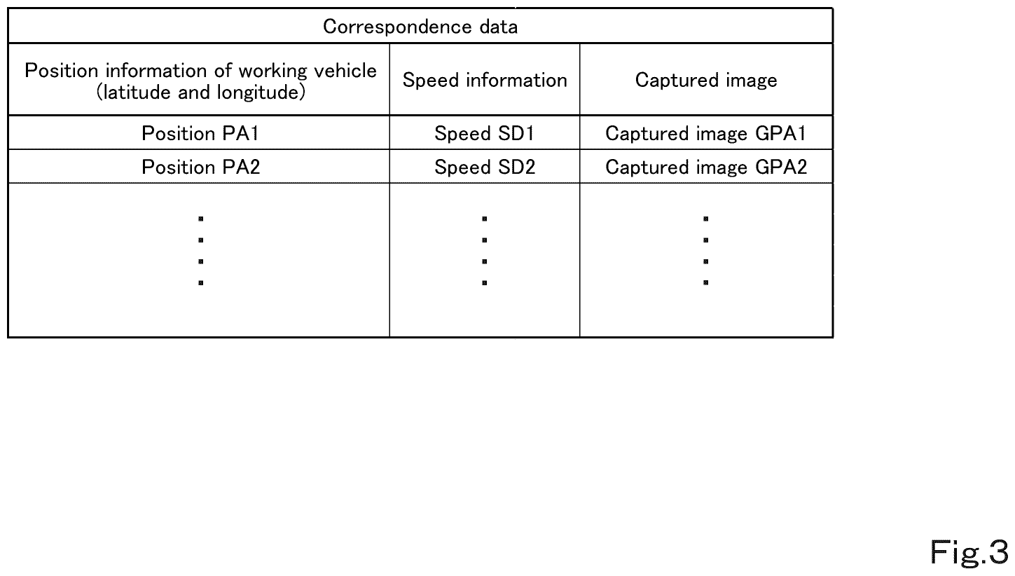

The detection information and the sensing information that are transmitted from the working vehicle 1 as described above include correspondence data (see FIG. 3) in which position information of the working vehicle 1, traveling information including the speed or acceleration of the working vehicle 1, and images captured in the traveling direction of the working vehicle 1 are associated to correspond to one another. FIG. 3 is a diagram illustrating an example of correspondence data. That is, pieces of correspondence data in which the detection information of the position detector 24 (namely, the position information of the working vehicle 1), the traveling information of the working vehicle 1 detected by the state detector 26, and the sensing information of the sensing device 25 (for example, images captured by the internal camera 25c1) are associated to correspond to one another are transmitted to the remote control apparatus 30 one after another. As illustrated in FIG. 3, correspondence data in which a position PA1 of the working vehicle 1, a speed SD1 of the working vehicle 1, and an image GPA1 captured by the camera 25c are associated to correspond to one another is transmitted to the remote control apparatus 30. In addition, correspondence data in which a position PA2 of the working vehicle 1, a speed SD2 of the working vehicle 1, and an image GPA2 captured by the camera 25c are associated to correspond to one another is transmitted to the remote control apparatus 30. As illustrated in FIG. 3, making mention of captured images, pieces of correspondence data in which forward captured images in a case of forward traveling (rearward captured images in a case of rearward traveling), the traveling information of the working vehicle 1, and the position information of the working vehicle 1 are associated to correspond to one another are transmitted to the remote control apparatus 30 one after another. Although it is described in the example embodiment above that correspondence data in which the position information of the working vehicle 1, the traveling information thereof, and captured images are associated to correspond to one another is included, the position information of the working vehicle 1, the traveling information thereof, and captured images may be acquired separately and may be associated with one another correspondingly based on time or the like.

Electric or hydraulic motors, cylinders, control valves, and the like to cause the components of the working vehicle 1 such as the prime mover 4, the traveling device 7, the transmission 5, the braking device 13, the coupling device 8, and the like to operate are included in the group of actuators 27. A steering wheel 11a (FIG. 2), an accelerator pedal, a brake pedal, a transmission shift lever 11d (FIG. 1), and the like are included in the manipulator 11. The vehicle-mounted controller 21 is configured or programmed to drive the prime mover 4, the traveling device 7, the transmission 5, the braking device 13, and the steering device 14 to control the traveling and steering of the working vehicle 1 by causing a predetermined actuator included in the group of actuators 27 to operate in accordance with a manipulation state of the manipulator 11.

Moreover, the vehicle-mounted controller 21 communicates with a controller 2a built in the working implement 2 to cause the controller 2a to control the operation of the working implement 2. That is, the vehicle-mounted controller 21 is configured or programmed to perform work on an agricultural field by indirectly controlling the operation of the working implement 2 via the controller 2a. The controller 2a includes, for example, a CPU, a memory, and the like. Some types of the working implement 2 are not equipped with the controller 2a. In this case, the vehicle-mounted controller 21 causes the working implement 2 to perform work on an agricultural field by controlling the attitude of the working implement 2 via the coupling device 8.

The vehicle-mounted controller 21 is configured or programmed to control the traveling of the working vehicle 1, work performed by the working implement 2, and other operations of the working vehicle 1 based on the sensing information of the sensing device 25, the detection information of the state detector 26, the detection information of the position detector 24, and the like. In a case where the vehicle-mounted controller 21 receives a remote manipulation signal transmitted from the remote control apparatus 30 via the vehicle-mounted communication module 23, the vehicle-mounted controller 21 controls the traveling of the working vehicle 1, work performed by the working implement 2, and other operations of the working vehicle 1 based on the remote manipulation signal in addition to each information mentioned above.

Furthermore, based on the detection information of the target object detector 25d, the vehicle-mounted controller 21 determines whether or not there is a risk of collision of the working vehicle 1 or the working implement 2 with a target object due to approaching within a predetermined distance when controlling the traveling of the working vehicle 1 or work performed by the working implement 2. Then, if it is determined that there is a risk of collision of the working vehicle 1 or the working implement 2 with a target object due to approaching within a predetermined distance, the vehicle-mounted controller 21 controls the traveling device 7 or the working implement 2, etc., to stop the traveling of the working vehicle 1 or stop the work, thus avoiding collision with the target object.

Next, the remote control apparatus 30 will now be explained. As illustrated in FIG. 1, the remote control apparatus 30 is disposed at a location away from the working vehicle 1. The remote control apparatus 30 enables a person performing remote manipulation (operator) to manipulate the working vehicle 1 remotely and monitor the state of the working vehicle 1 and surrounding situations around the working vehicle 1 and the like. The remote control apparatus 30 includes a controller 31, a storage 32, a communication module 33, a display 34, a manipulator 35, and a notifier 36.

The controller 31 is a processor configured or programmed to control the operation of each component of the remote control apparatus 30. For example, this processor runs a remote control program stored in the storage 32, thus functioning as the controller 31 configured to control the operation of each component of the remote control apparatus 30. An internal memory 32a provided in the controller 31 is a volatile or non-volatile memory. Various kinds of information and data to be used by the controller 31 to control the operation of each component of the remote control apparatus 30 are stored in a readable-and-writeable manner in the internal memory 32a.

Control programs such as a remote control program for remote driving of the working vehicle 1 and a remote monitoring program for remote monitoring of the working vehicle 1, various kinds of data, and the like have been stored in the storage 32 in advance. The storage 32 is, for example, an SSD (Solid State Drive), an HDD (Hard Disk Drive), or the like.

The communication module 33 includes an antenna for wireless communication via a cellular phone communication network or via the Internet or via a wireless LA N, and includes ICs and electric circuits and the like. The communication module 33 is configured or programmed to communicate with the working vehicle 1 wirelessly under the control of the controller 31. The communication module 33 receives various kinds of data transmitted from the vehicle-mounted communication module 23 (the detection information of the position detector 24, the detection information of the state detector 26, the sensing information of the sensing device 25, and the like). For example, the communication module 33 receives correspondence data in which the position information of the working vehicle 1, the traveling information of the working vehicle 1, and images captured in the traveling direction of the working vehicle 1 are associated to correspond to one another.

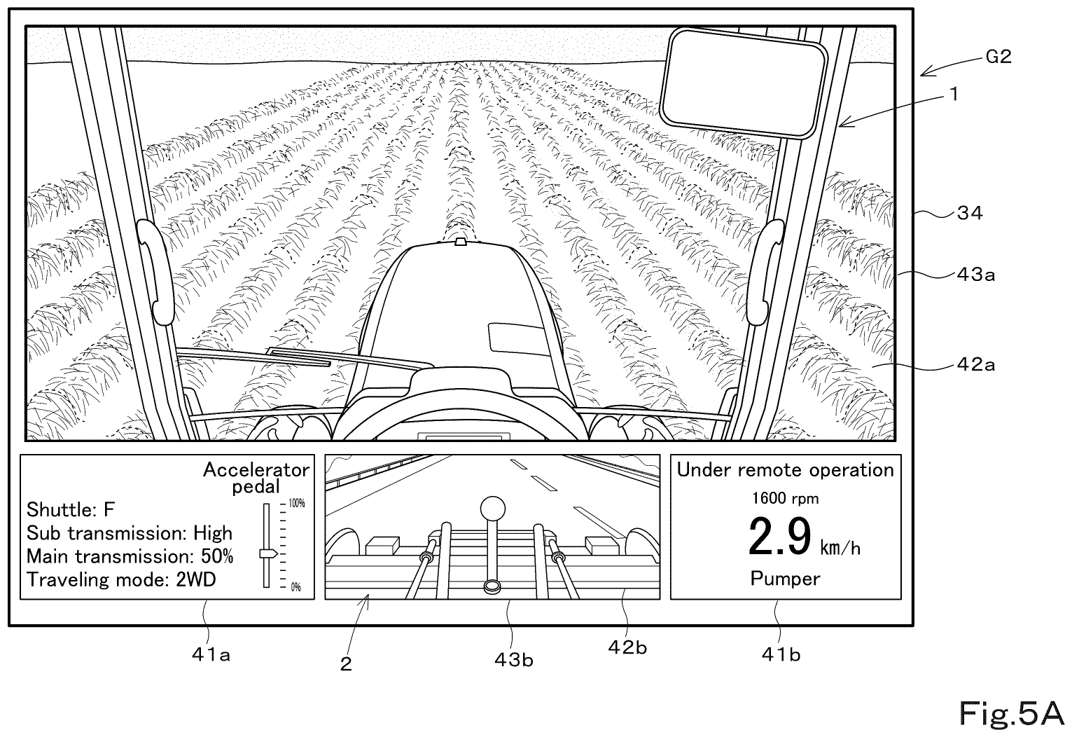

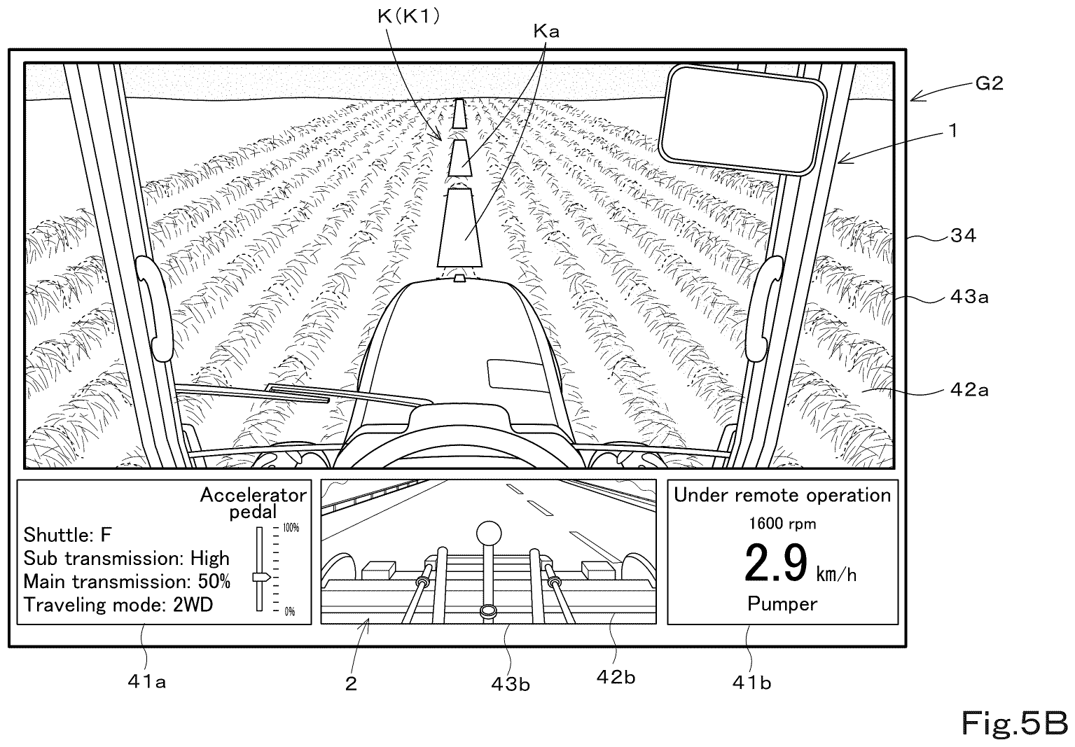

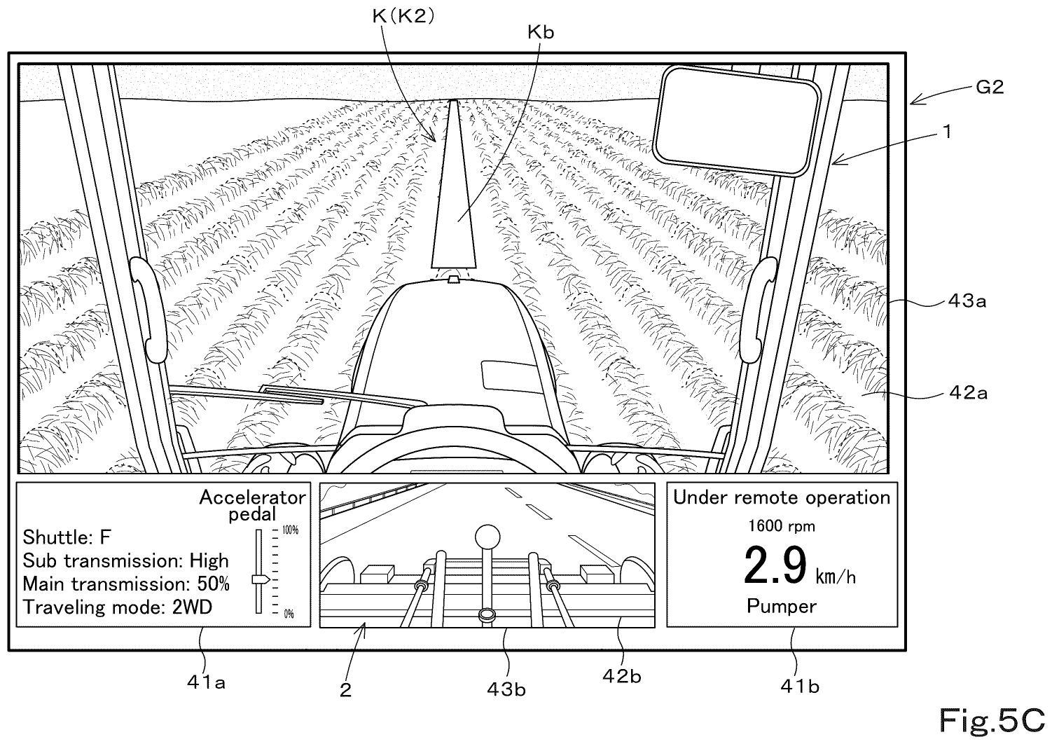

The display 34 is, for example, a liquid crystal display, an organic E L display, or the like. Under display control performed by the controller 31, the display 34 displays information for operating the working vehicle 1 remotely. FIG. 5A is a diagram illustrating an example of a remote driving screen G2 without highlighted display K. For example, the display 34 displays the remote driving screen G2 as illustrated in FIG. 5A.

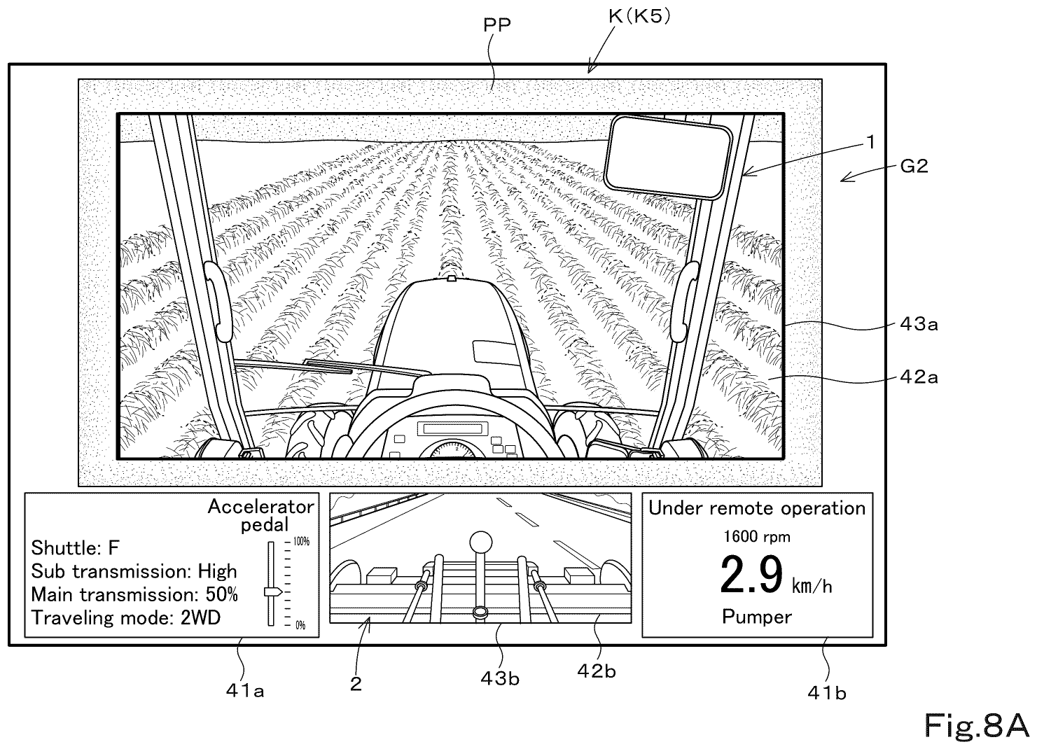

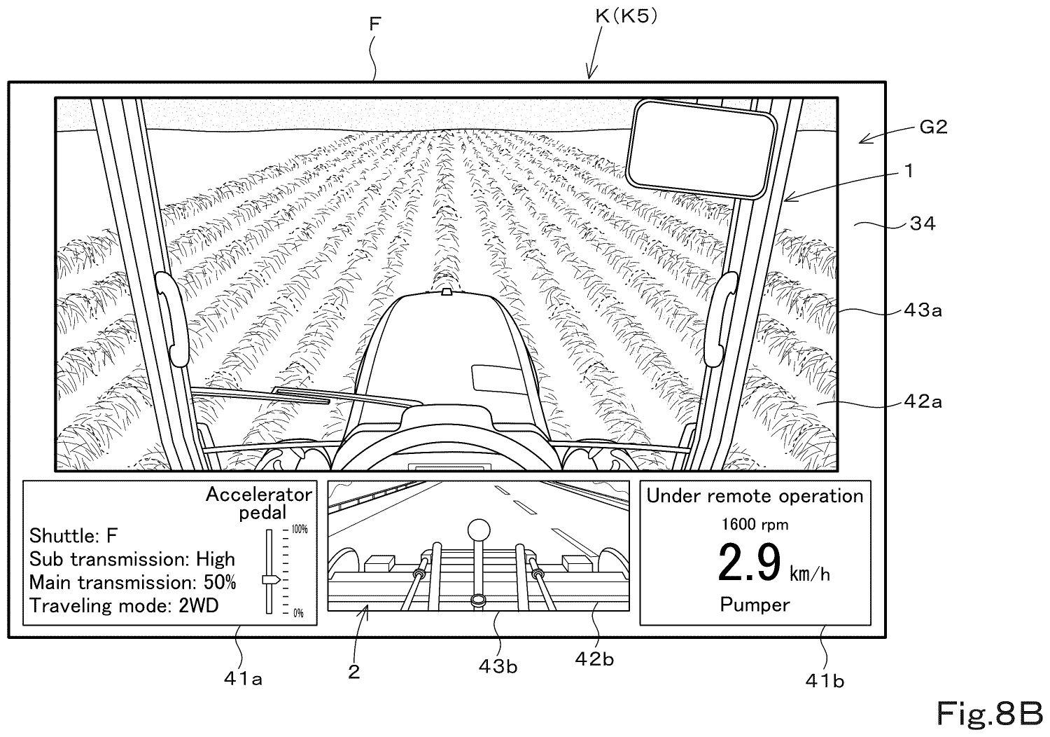

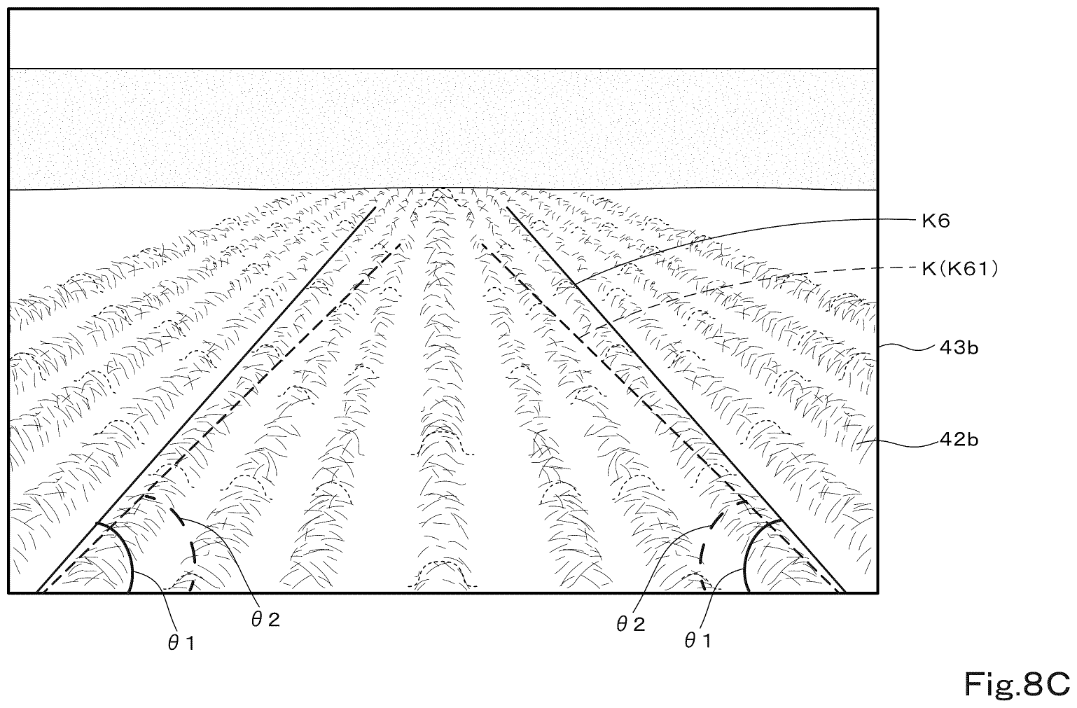

The remote driving screen G2 is a driving screen on which various kinds of information for operating the working vehicle 1 remotely are displayed. For example, the remote driving screen G2 includes a window 43a, in which a forward captured image 42a obtained by imaging a front area in front of the working vehicle 1 via the internal camera 25c1 is displayed, and a window 43b, in which a rearward captured image 42b obtained by imaging a rear area behind the working vehicle 1 via the rear camera 25c2 (FIG. 2) installed on the rear portion of the vehicle body 3 is displayed. The remote driving screen G2 may further include windows 41a and 41b, in which various kinds of information showing the state of the working vehicle 1 are displayed. That is, both the forward captured image 42a and the rearward captured image 42b are displayed. The controller 31 commands that the highlighted display K should be performed on the forward captured image 42a, etc., at the time of forward traveling and commands that the highlighted display K should be performed on the rearward captured image 42b at the time of rearward traveling. The remote driving screen G2 may be configured such that the forward captured image 42a only is displayed when the working vehicle 1 is traveling forward and the rearward captured image 42b only is displayed when the working vehicle 1 is traveling rearward (see FIG. 8C).

The display 34 includes, for example, a touch panel provided on the surface of a display screen, and is capable of detecting a touch operation on the display screen via the touch panel.

The controller 31 of the remote control apparatus 30 commands that the state of the working vehicle 1 detected by the position detector 24 and the vehicle-mounted controller 21 of the working vehicle 1 should be displayed in the windows 41a and 41b of the remote driving screen G2. In FIG. 5A, it is displayed in the window 41a as follows: the traveling direction of the traveling device 7 is a forward direction (“Shuttle: F”); the sub transmission of the transmission 5 is high-speed, (“Sub transmission: High”); the state of the main transmission (continuously variable transmission) is 50% (“Main transmission: 50%”); the working vehicle 1 is traveling in a two-wheel-drive mode (“Traveling mode: 2 W D”); and the operation amount of the accelerator pedal is 40%, for example. It is displayed in the window 41b as follows: the working vehicle 1 is traveling under remote operation (“Under remote operation”); the traveling speed of the working vehicle 1 (the vehicle body 3) is 2.9 km/h; and the number of revolutions of the prime mover 4 is 1,600 rpm, for example.

The information displayed in the window 41a, 41b is not limited to the state of the working vehicle 1 described above. The number of the windows 41a and 41b is not limited to two. The screen may have a single window only, or three or more windows. The controller 31 may command that not only the state of the working vehicle 1 but also whether the working implement 2 is coupled to the working vehicle 1 or not, the type of the working implement 2, and the like should be displayed in a window(s) of the remote driving screen G2 based on the detection information of the position detector 24, etc., and the sensing information of the sensing device 25.

The manipulator 35 is configured to manipulate the working vehicle 1 remotely. The manipulator 35 includes a handle 35a, an accelerator pedal 35b, a brake pedal 35c, and a transmission shift lever 35d, which are arranged around a remote operator's seat. The remote operator seated on the remote operator's seat manipulates the traveling of the working vehicle 1 or work performed by the working implement 2 remotely by operating the manipulator 35. Moreover, the remote operator monitors the working vehicle 1 and surrounding situations around the working vehicle 1 via the display 34. Furthermore, the remote operator is able to input predetermined information or instructions into the remote control apparatus 30 by operating the manipulator 35. The manipulator 35 may be a touch pad, a hardware switch, or the like.

The notifier 36 includes speakers 36a configured to perform sound/voice outputting to the remote operator. Note that the notifier 36 is not limited to the speakers 36a, and may include the display 34 instead of or in addition to the speakers 36a.

When the remote operator operates the manipulator 35 to input operation instructions for operating the working vehicle 1, the controller 31 generates a remote manipulation signal corresponding to the operation instructions and transmits the remote manipulation signal to the working vehicle 1 via the communication module 33. That is, a remote manipulation signal corresponding to the operation of the handle 35a, the accelerator pedal 35b, the brake pedal 35c, and the transmission shift lever 35d is transmitted to the working vehicle 1. Upon receiving the remote manipulation signal from the remote control apparatus 30 via the vehicle-mounted communication module 23, the vehicle-mounted controller 21 of the working vehicle 1 controls the traveling and steering of the working vehicle 1 and the work operation of the working implement 2 by causing each component of the working vehicle 1 to operate based on the remote manipulation signal, the detection information of the position detector 24, the sensing information of the sensing device 25, and the detection information of the state detector 26.

The vehicle-mounted controller 21 transmits the detection information of the position detector 24, the detection information of the state detector 26, and the sensing information of the sensing device 25 to the remote control apparatus 30 via the vehicle-mounted communication module 23. Upon receiving the detection information of the position detector 24, the detection information of the state detector 26, and the sensing information of the sensing device 25 via the communication module 33, the controller 31 of the remote control apparatus 30 causes the internal memory 32a to store these kinds of information and causes the display 34 to display them.

As illustrated in FIG. 1, the remote control apparatus 30 may be made up of a display terminal 70 and the manipulator 35. That is, the display terminal 70 may be a terminal device that includes the controller 31, the storage 32, the communication module 33, and the display 34, and may further include the speakers 36a. Some examples of the display terminal 70 are a handheld terminal device such as a tablet device or a smartphone, or an installed computer installed at a base station (not illustrated). The display terminal 70 may be a user interface device.

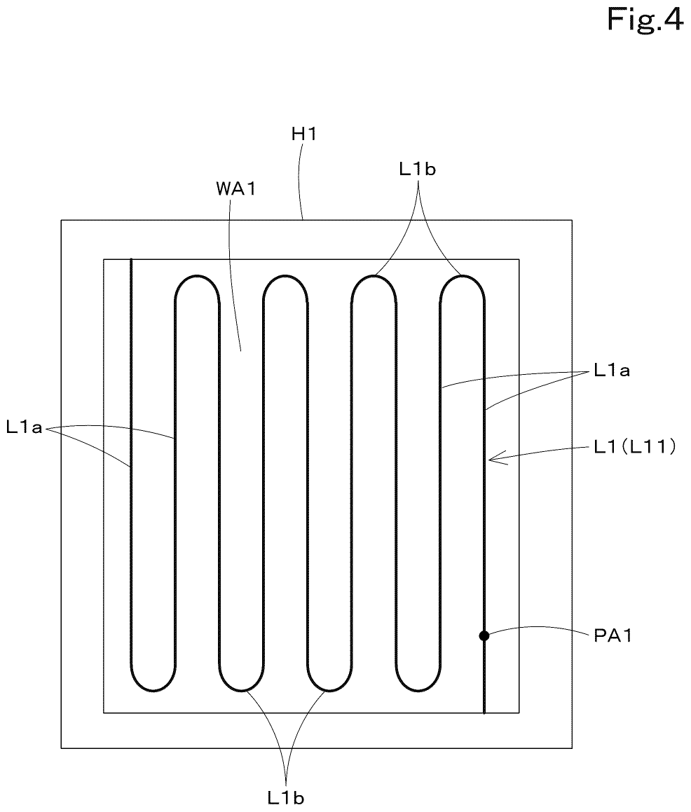

A planned traveling route L of the working vehicle 1 will now be explained in detail. FIG. 4 is a diagram illustrating an example of the planned traveling route L. The remote control apparatus 30 is capable of setting the planned traveling route L. For example, map information that includes an agricultural field H1 has been stored in the storage 32 in advance. In a case where map information that includes an agricultural field H1 has not been stored in the storage 32 in advance, the remote control apparatus 30 is capable of acquiring the map information that includes the agricultural field H1 by accessing a non-illustrated map server and causing the storage 32 to store the acquired map information. The controller 31 reads the map information that includes the agricultural field H1 out of the storage 32 and causes the display 34 to display the agricultural field H1 illustrated in FIG. 4 on its display screen. The remote operator is able to set the planned traveling route L in the work area WA1 of the agricultural field H1 in advance as illustrated in FIG. 4 by performing a touch operation (for example, a pen input operation) in the work area WA1 on the display screen of the display 34. The planned traveling route L includes a plurality of straight paths L1a and a plurality of semicircular-arc turning paths L1b, each of which connects an end of one of two straight paths L1a located next to each other to an end of the other of these two mutually-adjacent straight paths L1a. The planned traveling route L having been set is registered into the storage 32.

The working vehicle 1 is capable of setting the planned traveling route L in advance. For example, the vehicle-mounted controller 21 of the working vehicle 1 is capable of setting the planned traveling route L in the work area WA1 of the agricultural field H1 as a result of actually driving the working vehicle 1 in the agricultural field H1 by the operator seated in the working vehicle 1. The remote control apparatus 30 may receive the planned traveling route L having been set in this way from the working vehicle 1 and cause the storage 32 to store it.

By the way, unlike general vehicles such as automobiles, the speed range of working vehicles 1 such as tractors is biased to a low-speed range. For this reason, even in a case where an operator is actually seated in a working vehicle 1 and actually drives the working vehicle 1 (actual driving), it is less easy for the operator to perceive a change in vehicle speed physically. Moreover, remote driving makes it more difficult to feel a vehicle speed by physical perception. What makes matters even more difficult is the lack of markings such as a center line and poorness in changes in ambient scenery, which makes the vehicle speed harder to feel by physical perception when the vehicle is traveling on an agricultural field such as a rice paddy, a field, a pastureland, or the like.

In view of the above problem, the remote manipulation system 100 and the remote control apparatus 30 according to the present example embodiment cause the display 34 to perform vehicle-speed-highlighted display K, for example, as illustrated in FIG. 5B, thus making it easier for the remote operator to perceive the speed of the working vehicle 1 physically. FIG. 5B is a diagram illustrating an example of a remote driving screen G2 with highlighted display K. The highlighted display K changes in accordance with traveling information and is performed in an emphasized manner as compared to a manner in which the working vehicle 1 is actually traveling. For example, the highlighted display K changes in accordance with the traveling information and gives an impression that the working vehicle 1 is traveling in a state equal to or greater than an actual state in which the working vehicle 1 is actually traveling. The highlighted display K changes in accordance with the traveling information and gives an impression that the working vehicle 1 is traveling at a speed or acceleration greater than an actual speed or acceleration of the working vehicle 1. Herein, highlighted display may generally refer to information displayed instead of or in addition to other (conventionally) displayed information and that is shown in an emphasized manner as compared to the other displayed information. For instance, the display may perform highlighted display instead of or in addition to displaying the traveling speed of the working vehicle 1 (e.g., 2.9 km/h in FIG. 5B) and/or the number of revolutions of the prime mover 4 (e.g., 1600 rpm in FIG. 5B). The highlighted display may be performed in another portion of the display than the traveling speed and/or number of revolutions display. Highlighted display may comprise displaying a graphical sign, e.g., a sign different from alphanumerical characters.

When the working vehicle 1 is manipulated remotely via the manipulator 35, the controller 31 causes the display 34 to perform highlighted display K that changes in accordance with the traveling information. For example, the controller 31 causes the display 34 to perform vehicle-speed-highlighted display K that changes in accordance with the speed or acceleration of the working vehicle 1 that is indicated by the traveling information. The speed of the working vehicle 1 mentioned here is any of a speed per unit time such as a speed per hour, a speed per minute, or a speed per second or an acceleration that is the rate of change of speed. For example, the controller 31 may calculate a value by multiplying by a pre-stored coefficient the actual measured value of the speed or acceleration detected by the state detector 26 (value measured by a speed sensor or an acceleration sensor), convert the calculated value into the value of speed, the value of acceleration, the value of color, or the like indicated by the highlighted display K, and cause the display 34 to display the obtained value.

Specifically, when the working vehicle 1 is driven remotely, the communication module 33 receives captured images of the traveling direction of the working vehicle 1 one after another. The display 34 displays the captured images on the remote driving screen G2 one after another. The controller 31 commands that highlighted display K should be performed on the remote driving screen G2 in a case where a first condition, which will be described later, is met. M ore particularly, the controller 31 commands that one highlighted display K selected from among highlighted display K of first to eighth modes should be performed in a case where the first condition is met.

Highlighted display K of a first display mode is illustrated in FIG. 5B. For example, as the highlighted display K of the first display mode, the controller 31 commands that superimposed display on the captured image should be performed on the remote driving screen G2. As the highlighted display K of the first display mode, the controller 31 commands that superimposed display of a sign K1 extending in the traveling direction of the working vehicle 1 should be performed, and, in addition, commands that the moving display speed of the sign K1 should be changed in accordance with the speed or acceleration of the working vehicle 1. The sign K1 is, for example, a broken-line demarcation line (a broken-line center line, a broken-line “between-lanes” borderline, or the like) and includes a plurality of line segments K a arranged in a row along the traveling direction of the working vehicle 1.

The controller 31 commands that the highlighted display should be performed in such a manner that the speed perceived physically by the remote operator who sees the remote driving screen G2 will be higher than the actual speed. The controller 31 commands that the highlighted display K should be performed in such a manner that the speed perceived physically by the remote operator who sees the display of the display 34 will be higher than the actual speed when the actual speed of the working vehicle 1 per unit time (speed per hour or the like) or the acceleration thereof increases. Moreover, the controller 31 commands that the highlighted display K should be performed in such a manner that the speed perceived physically by the remote operator will be higher than the actual speed even when the actual speed of the working vehicle 1 per unit time or the acceleration thereof decreases.

As the speed or acceleration of the working vehicle 1 increases, so does the moving speed of display. As the speed or acceleration of the working vehicle 1 decreases, so does the moving speed of display. However, preferably, the speed perceived physically by the remote operator should be higher than the actual speed of the vehicle in both of these cases.

In general, the speed range of working vehicles 1 (for example, tractors) is biased to a low-speed range, and it is less easy for an operator to recognize the speed in a case of remote driving. However, the highlighted display K described above can produce highlighting effects such that the speed perceived physically will be higher than the actual speed.

Moreover, the controller 31 commands that the highlighted display K should be performed in such a manner that the acceleration perceived physically by the remote operator will be higher than the actual acceleration of the working vehicle 1 when the actual acceleration of the working vehicle 1 increases. In addition, the controller 31 commands that the highlighted display K should be performed in such a manner that the speed or acceleration perceived physically by the remote operator will be higher than the actual speed or acceleration of the working vehicle 1 also when the speed or the acceleration of the working vehicle 1 decreases.

For example, in the highlighted display, when the traveling speed of the working vehicle 1 is 1 km/h, the moving display speed of the sign K1 on the remote driving screen G2 is set to be a first moving display speed. The first moving display speed may be equal to the actual speed [1 km/h] or a speed that is higher than the actual speed (a speed calculated by multiplying the actual speed by a coefficient that is greater than 1 in accordance with an increase in the actual speed or acceleration). Then, in the highlighted display, when the traveling speed of the working vehicle 1 is 2 km/h, the moving display speed of the sign K1 is set to be a second moving display speed that is higher than the first moving display speed. As long as the second moving display speed is higher than the first moving display speed, the second moving display speed may be equal to the actual speed [2 km/h] or a speed that is higher than the actual speed.

The controller 31 commands that the highlighted display K should be performed on the remote driving screen G2 as illustrated in FIG. 5B, etc., when the first condition is met, and commands that the highlighted display K should not be performed on the remote driving screen G2 as illustrated in FIG. 5A when the first condition is not met.

Specifically, the controller 31 determines that the first condition is met in a case where an amount of change between a plurality of captured images is less than a threshold value, and determines that the first condition is not met in a case where the amount of change between the plurality of captured images is not less than the threshold value. For example, the controller 31 can perform this determination by determining whether or not the amount of change between the plurality of captured images is not less than the threshold value by performing known difference image processing. For example, the controller 31 generates a difference image that is a difference between two captured images. Then, with regard to a predetermined range in the difference image, in a case where the total number of difference pixels of a predetermined value or greater is less than a predetermined number, the controller 31 determines that the amount of change between the plurality of captured images is less than the threshold value and thus determines that the first condition is met. The predetermined range may be the whole of the difference image or a portion of the difference image (for example, a portion corresponding to a road surface solely). On the other hand, in a case where the total number of difference pixels of the predetermined value or greater is not less than the predetermined number, the controller 31 determines that the amount of change between the plurality of captured images is not less than the threshold value and thus determines that the first condition is not met.

Moreover, the controller 31 determines that the first condition is met in a case where no road-surface marking is included in the captured image, and determines that the first condition is not met in a case where a road-surface marking is included in the captured image. Examples of the road-surface marking include markings on the surface of a road (markings for traffic instructions such as a center line, a borderline between traffic lanes, regulatory markings such as traffic regulation marks, and the like). The controller 31 determines that the first condition is met in a case where no road-surface marking is included in the captured image, which is determined by performing known image analysis processing (for example, pattern matching processing). That is, it is possible to determine that the area where the working vehicle 1 is traveling under remote driving is an area that is poor in changes in ambient scenery (for example, a pastureland, a field, or the like). On the other hand, the controller 31 determines that the first condition is not met in a case where a road-surface marking is included in the captured image, which is determined by performing known image analysis processing (for example, pattern matching processing). That is, it is possible to determine that the area where the working vehicle 1 is traveling under remote driving is an area that is rich in changes in ambient scenery (for example, an ordinary road).

FIG. 5C is a diagram illustrating highlighted display K of a second display mode on the remote driving screen G2. As the highlighted display K of the second display mode, as illustrated in FIG. 5C, the controller 31 is capable of commanding that a sign K2 extending in the traveling direction of the working vehicle 1 should be displayed in a superimposed manner on a captured image on the remote driving screen G2, and, in addition, commanding that the color of the sign K2 should be varied in accordance with the speed of the working vehicle 1. The sign K2 is, for example, a solid-line demarcation line (a solid-line center line, a solid-line “between-lanes” borderline, or the like) and is configured to be a single line K b extending in the traveling direction of the working vehicle 2.

Specifically, the controller 31 commands that the color of the highlighted display K of the second display mode (the sign K2) on the remote driving screen G2 illustrated in FIG. 5C should be varied in accordance with the speed (traveling speed) of the working vehicle 1. For example, the sign K2 is displayed in blue when the speed of the working vehicle 1 is low, and is displayed in red when the speed of the working vehicle 1 is high. Moreover, for example, the controller 31 may command that the color of the highlighted display K (the sign K2) should be varied in the order of green, yellow green, yellow, yellowish orange, orange, reddish orange, and red in the Ostwald color system as the traveling speed increases. For example, the color of the highlighted display K is green when the traveling speed is 0 km/h, and, each time the traveling speed increases by a unit speed increment (for example, 0.5 km/h), the color of the highlighted display K changes therefrom in the order of yellow green, yellow, yellowish orange, orange, reddish orange, and red. This is a mere example. The order of the change may be purple, indigo blue, blue, green, yellow, orange, and red, or may be green, yellow, orange, and red.

The controller 31 may command that the color of the highlighted display K of the first display mode (the sign K1) on the remote driving screen G2 illustrated in FIG. 5B should be varied in accordance with the speed (traveling speed) of the working vehicle 1.

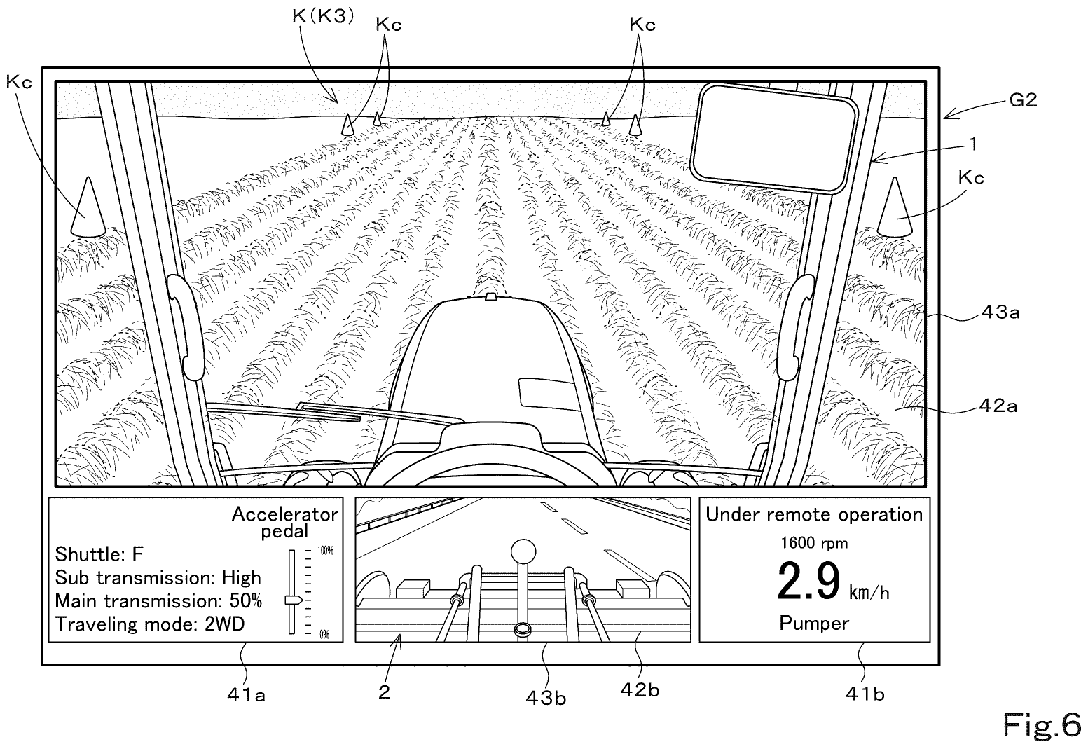

FIG. 6 is a diagram illustrating highlighted display K of a third display mode on the remote driving screen G2. As the highlighted display K of the third display mode, as illustrated in FIG. 6, the controller 31 is capable of commanding that a plurality of virtual signs Kc arranged along the traveling direction of the working vehicle 1 should be displayed in a superimposed manner on a captured image on the remote driving screen G2, and, in addition, commanding that the moving display speed of the plurality of virtual signs Kc should be changed in accordance with the speed of the working vehicle 1. The virtual sign K c is, for example, a road cone, a pole, or the like. The highlighted display K3 illustrated in FIG. 6 includes the plurality of virtual signs Kc.

For example, when the traveling speed of the working vehicle 1 is 1 km/h, the controller 31 sets the moving display speed of the plurality of virtual signs Kc on the remote driving screen G2 to be a first moving display speed. The first moving display speed may be the same as the actual speed [1 km/h] or different therefrom. Then, when the traveling speed of the working vehicle 1 is 2 km/h, the controller 31 sets the moving display speed of the plurality of virtual signs Kc to be a second moving display speed that is higher than the first moving display speed. As long as the second moving display speed is higher than the first moving display speed, the second moving display speed may be the same as the actual speed [2 km/h] or different therefrom.

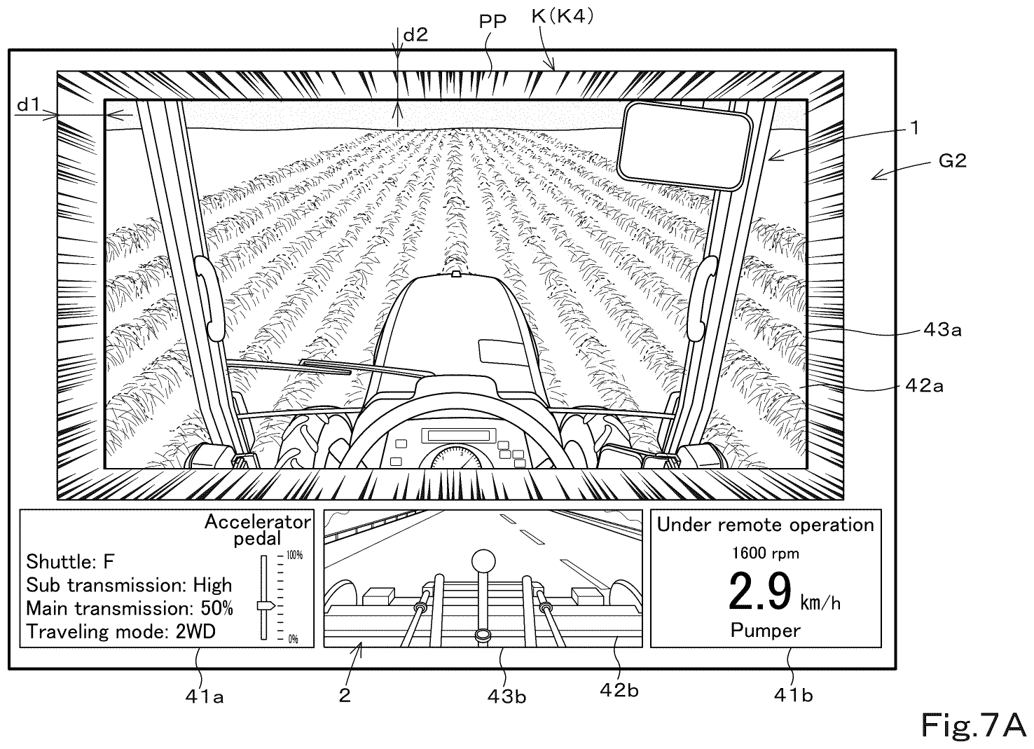

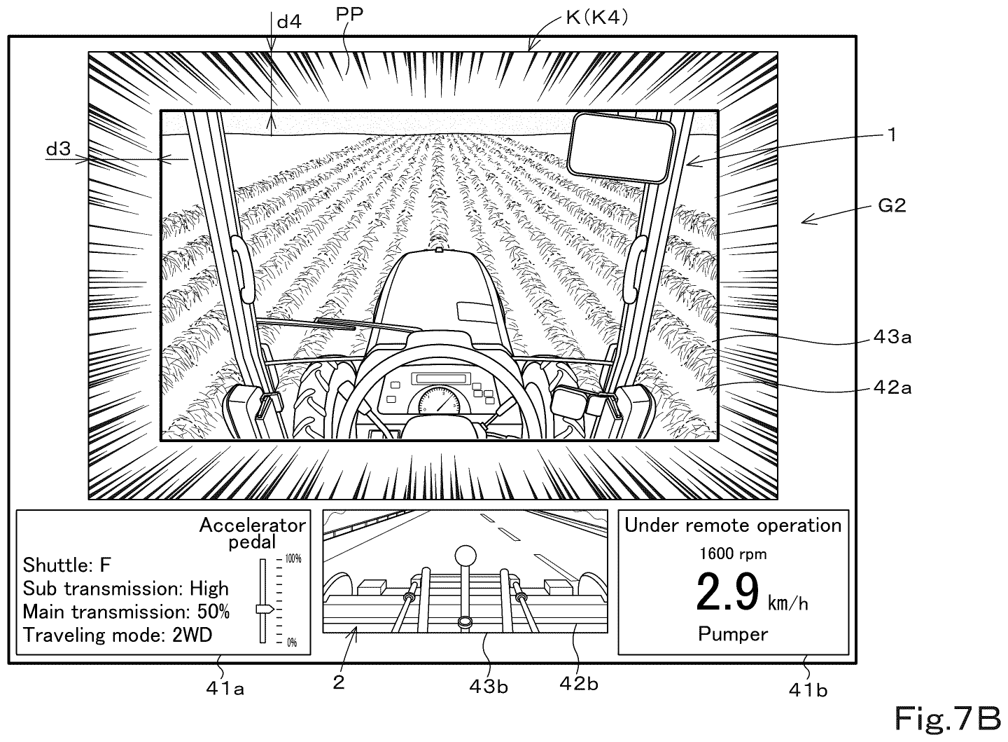

FIG. 7A is a diagram illustrating highlighted display K of a fourth display mode on the remote driving screen G2. As illustrated in FIG. 7A, the controller 31 is capable of commanding that the highlighted display K of the fourth display mode should be performed on a peripheral portion PP of the remote driving screen G2. The highlighted display K of the fourth display mode may be performed on the peripheral portion PP of a captured image. The peripheral portion PP corresponds to an acceleration-effects rendering area K4. It can be said that the peripheral portion PP is an area where the acceleration-effects rendering area K4 is displayed. For example, the controller 31 changes the region of the peripheral portion PP in accordance with the speed or acceleration of the working vehicle 1. The phrase “changes the region of the peripheral portion PP” mentioned here encompasses the meaning of changing its area size, changing its design such as shape and/or color, and the like. In the example disclosed here, the controller 31 increases the area size of the region of the peripheral portion PP (that is, the acceleration-effects rendering area K4) when the speed or acceleration of the working vehicle 1 increases. The acceleration-effects rendering area K4 has a rectangular frame shape. Therefore, the acceleration-effects rendering area K4 includes a left edge portion, a top edge portion, a right edge portion, and a bottom edge portion. In the acceleration-effects rendering area K4 illustrated in FIG. 7A, for example, the horizontal width d1 of the left edge portion is equal to that of the right edge portion, and the vertical width d2 of the top edge portion is equal to that of the bottom edge portion. However, there may be a difference therebetween.

In the acceleration-effects rendering area K4, speed-effect lines for imparting a sense of speed to the captured image are drawn in a substantially-radially-extending manner from the contour edges of the captured image. That is, speed-lines display is performed on the acceleration-effects rendering area K4. The controller 31 commands that a captured image having its original size corresponding to the entirety of the remote driving screen G2 should be displayed in a size-reduced manner such that the size-reduced captured image will fit in an area excluding the peripheral portion PP of the remote driving screen G2; however, the manner of display is not limited to this example. For example, the controller 31 may command that the acceleration-effects rendering area K4 having a rectangular frame shape should be displayed in a superimposed manner on the captured image without changing the original size of the captured image corresponding to the entirety of the remote driving screen G2. In this case, the acceleration-effects rendering area K4 may be displayed in a transparent or semi-transparent manner, except for its speed-effect-imparting black lines.

The controller 31 commands that the acceleration-effects rendering area K4 should be displayed with an increase in size as the speed or acceleration of the working vehicle 1 increases. In the acceleration-effects rendering area K4 illustrated in FIG. 7B, for example, the horizontal width d3 of each of the left edge portion and the right edge portion is greater than each horizontal width d1, and, in addition, the vertical width d4 of each of the top edge portion and the bottom edge portion is greater than each vertical width d2. Therefore, the acceleration-effects rendering area K4 illustrated in FIG. 7B has a larger size than the acceleration-effects rendering area K4 illustrated in FIG. 7A. That is, the controller 31 commands that the acceleration-effects rendering area K4 should be displayed with an increase in each horizontal width and each vertical width as the speed or acceleration of the working vehicle 1 increases. The horizontal width d3 of the left edge portion of the acceleration-effects rendering area K4 illustrated in FIG. 7B is equal to that of the right edge portion thereof, and the vertical width d4 of the top edge portion thereof is equal to that of the bottom edge portion thereof. However, there may be a difference therebetween.

In a case where the first condition is met, for example, the controller 31 may command that the acceleration-effects rendering area K4 illustrated in FIG. 7A should be displayed on the remote driving screen G2 if the traveling speed of the working vehicle 1 is 1 km/h and the acceleration-effects rendering area K4 illustrated in FIG. 7B should be displayed on the remote driving screen G2 if the traveling speed of the working vehicle 1 is 2 km/h. The controller 31 may, for example, command that the acceleration-effects rendering area K4 illustrated in FIG. 7A should be displayed on the remote driving screen G2 if the acceleration of the working vehicle 1 is a first acceleration and the acceleration-effects rendering area K4 illustrated in FIG. 7B should be displayed on the remote driving screen G2 if the acceleration of the working vehicle 1 is a second acceleration that is greater than the first acceleration.

The controller 31 is capable of commanding that an acceleration-effects rendering area K5 illustrated in FIG. 8A should be displayed in place of the acceleration-effects rendering area K4 illustrated in FIGS. 7A and 7B. FIG. 8A is a diagram illustrating highlighted display K of a fifth display mode on the remote driving screen G2. The display mode of the acceleration-effects rendering area K4 illustrated in FIG. 7A and FIG. 7B is a mode in which speed-effect lines for imparting a sense of speed to the captured image are drawn. On the other hand, the display mode of the acceleration-effects rendering area K5 illustrated in FIG. 8A is a mode in which a blur for imparting a sense of speed to the captured image is added. That is, as the highlighted display K of the fifth display mode, the acceleration-effects rendering area K5 illustrated in FIG. 8A is displayed. For example, the acceleration-effects rendering area K5 is shown in such a manner that the density of the blur for imparting a sense of speed to the captured image increases as it goes away from the contour edges of the captured image substantially radially. That is, blurring display is performed on the acceleration-effects rendering area K5. As is the case with the acceleration-effects rendering area K4 illustrated in FIG. 7A and FIG. 7B, the controller 31 is capable of commanding that the acceleration-effects rendering area K5 should be displayed with an increase in size as the speed or acceleration of the working vehicle 1 increases.

As the highlighted display K, the controller 31 is capable of commanding that the color of a particular portion (for example, the window 41a, 41b) other than the captured image of the remote driving screen G2 should be varied in accordance with the speed or acceleration of the working vehicle 1. For example, the controller 31 commands that highlighted display K of a sixth display mode, in which the color of a particular portion of the remote driving screen G2 illustrated in FIG. 5A is varied, should be performed. For example, the particular portion of the remote driving screen G2 is displayed in blue when the speed of the working vehicle 1 is low. The particular portion of the remote driving screen G2 is displayed in red when the speed of the working vehicle 1 is high. Moreover, for example, the controller 31 may command that the color of the particular portion of the remote driving screen G2 should be varied in the order of green, yellow green, yellow, yellowish orange, orange, reddish orange, and red in the Ostwald color system as the traveling speed increases. The color of the entire remote driving screen G2 may be varied.

FIG. 8B is a diagram illustrating highlighted display K of a seventh display mode on the remote driving screen G2. As the highlighted display K, the controller 31 is capable of commanding that the color of a frame F of the remote driving screen G2 should be varied in accordance with the speed or acceleration of the working vehicle 1. As illustrated in FIG. 8B, the controller 31 commands that the color of the frame F of the remote driving screen G2 should be varied. For example, the frame F of the remote driving screen G2 is displayed in blue when the speed of the working vehicle 1 is low. The frame F of the remote driving screen G2 is displayed in red when the speed of the working vehicle 1 is high. Moreover, for example, the controller 31 may command that the color of the frame F of the remote driving screen G2 should be varied in the order of green, yellow green, yellow, yellowish orange, orange, reddish orange, and red in the Ostwald color system as the traveling speed increases.

FIG. 8C is a diagram illustrating highlighted display K of an eighth display mode in the window 43b on the remote driving screen G2. As illustrated in FIG. 8C, when the working vehicle 1 is traveling rearward, the controller 31 commands that an image(s) captured at the time of rearward traveling of the working vehicle 1 should be displayed on the remote driving screen G2, and commands that a guide line(s) K6 should be displayed on the remote driving screen G2. The guide line K6 is, for example, a line indicating an anticipated course of the working vehicle 1 at the time of rearward traveling, a parking guide line for the working vehicle 1, a line indicating an anticipated course of the working implement 2 attached to the working vehicle 1. In FIG. 8C, a pair of guide lines K6 each having an angle θ1 are shown. As the highlighted display K, the controller 31 is capable of commanding that the mode (form or color) of the guide line K6 displayed on the remote driving screen G2 should be varied in accordance with the speed or acceleration of the working vehicle 1. For example, in accordance with the speed or acceleration of the working vehicle 1, the angle of the pair of guide lines K6 changes from the angle θ1 to an angle θ2. The angle θ2 is less than the angle θ1. That is, a guide line K61 the angle of which decreases as the speed or acceleration of the working vehicle 1 increases is displayed. Conversely, a guide line K61 the angle of which increases may be displayed. The color of the guide line K61 displayed may be varied.

For example, the controller 31 commands that the guide line K6 illustrated in FIG. 8C should be displayed on the remote driving screen G2 when the traveling speed of the working vehicle 1 traveling rearward is 1 km/h, and commands that the guide line K6 illustrated in FIG. 8C should be changed into the guide line K61 illustrated therein when the traveling speed of the working vehicle 1 traveling rearward is 2 km/h.

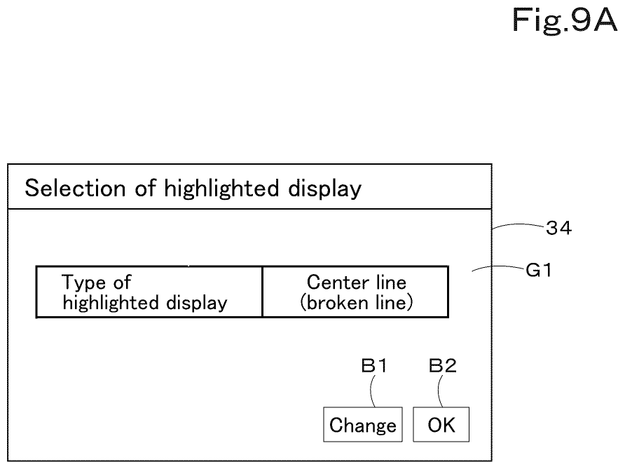

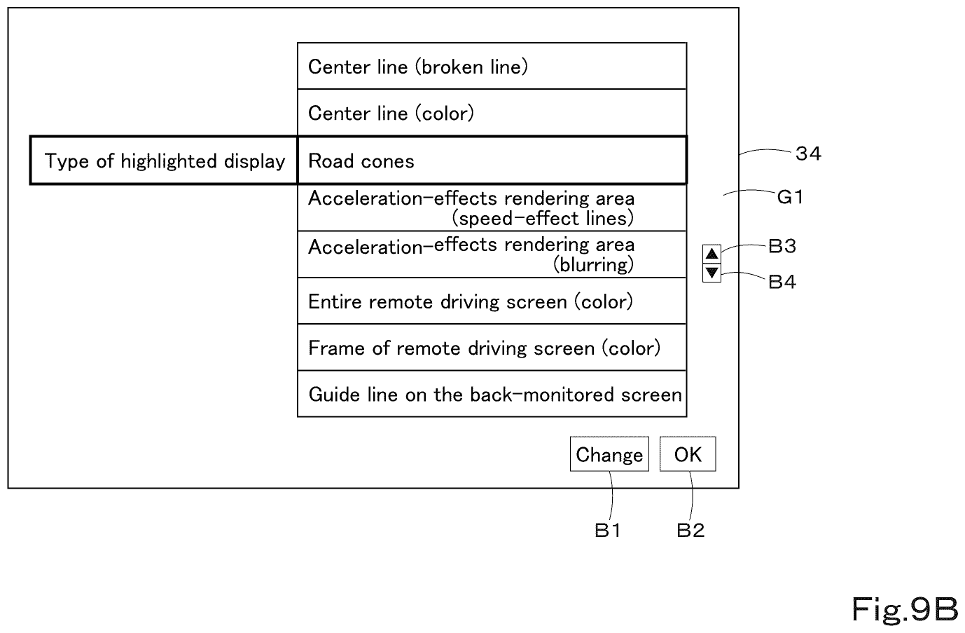

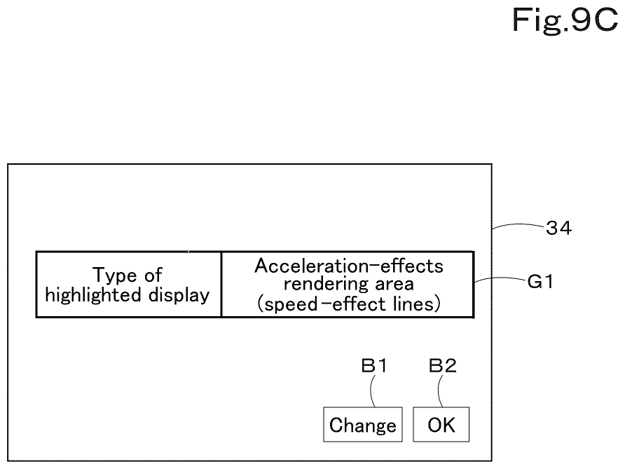

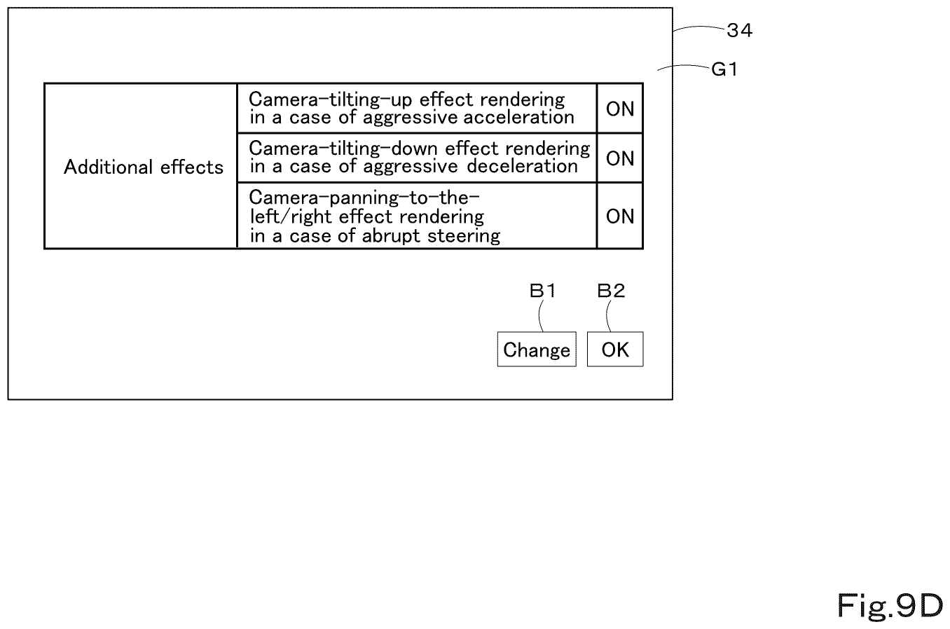

The controller 31 is capable of selecting a type of the highlighted display K from among that of the first to eighth display modes in accordance with a selection operation performed by the remote operator. Each of FIGS. 9A to 9C is a diagram illustrating an example of a selection screen G1 on the display 34. In response to a selection operation performed on the selection screen G1, the controller 31 is capable of commanding a change into the highlighted display K selected from among the highlighted display K of the first to eighth display modes. Specifically, when an instruction for selection of the highlighted display K is given by the remote operator, the controller 31 causes the display 34 to display the selection screen G1 as illustrated in FIG. 9A. On the selection screen G1 illustrated in FIG. 9A, it is shown that the currently-set type of highlighted display is center-line display (broken line) illustrated in FIG. 5B.

When the remote operator touches a Change button B1 on the selection screen G1 illustrated in FIG. 9A, the controller 31 causes the display 34 to display selectable items that indicate types of the highlighted display K of the first to eighth display modes as illustrated in FIG. 9B. The display 34 displays eight selectable items that include the highlighted display K of the first display mode illustrated in FIG. 5B (center line (broken line)), the highlighted display K of the second display mode illustrated in FIG. 5C (center line (color)), the highlighted display K of the third display mode illustrated in FIG. 6 (road cones), the highlighted display K of the fourth display mode illustrated in FIG. 7A (acceleration-effects rendering area K4 (speed-effect lines)), the highlighted display K of the fifth display mode illustrated in FIG. 8A (acceleration-effects rendering area K5 (blurring)), the highlighted display K of the sixth display mode (the color of the entire remote driving screen G2), the highlighted display K of the seventh display mode illustrated in FIG. 8B (the color of the frame F of the remote driving screen G2), and the highlighted display K of the eighth display mode illustrated in FIG. 8C (guide line K6 on the back-monitored screen). The controller 31 commands that the selectable items should be scrolled up each time the remote operator presses an Up button B3, and commands that the selectable items should be scrolled down each time the remote operator presses a Down button B4. FIG. 9B illustrates a state in which the set type has been changed to the highlighted display K of the third display mode illustrated in FIG. 6 (road cones) as a result of pressing the Down button B4 twice.

As illustrated in FIG. 9C, when an OK button B2 is pressed by the remote operator, the controller 31 regards the highlighted display K of the selected item as having been decided. FIG. 9C illustrates that the decided type is the highlighted display K of the fourth display mode illustrated in FIG. 7A (acceleration-effects rendering area K4 (speed-effect lines)). The controller 31 may change the type of the highlighted display K in response to operating a single selection button or a plurality of selection buttons (not illustrated) disposed near/around the operator's seat 10.

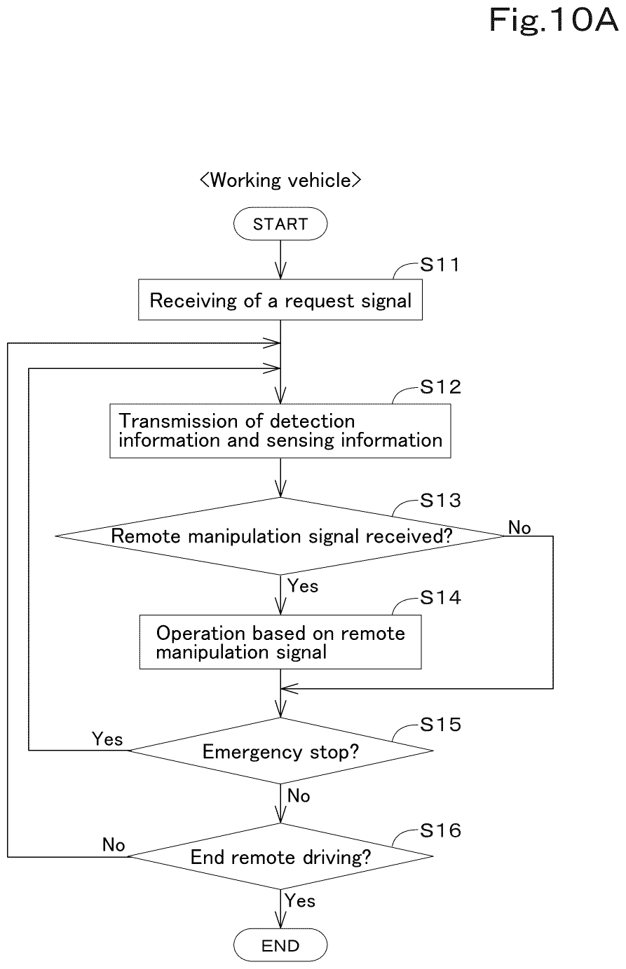

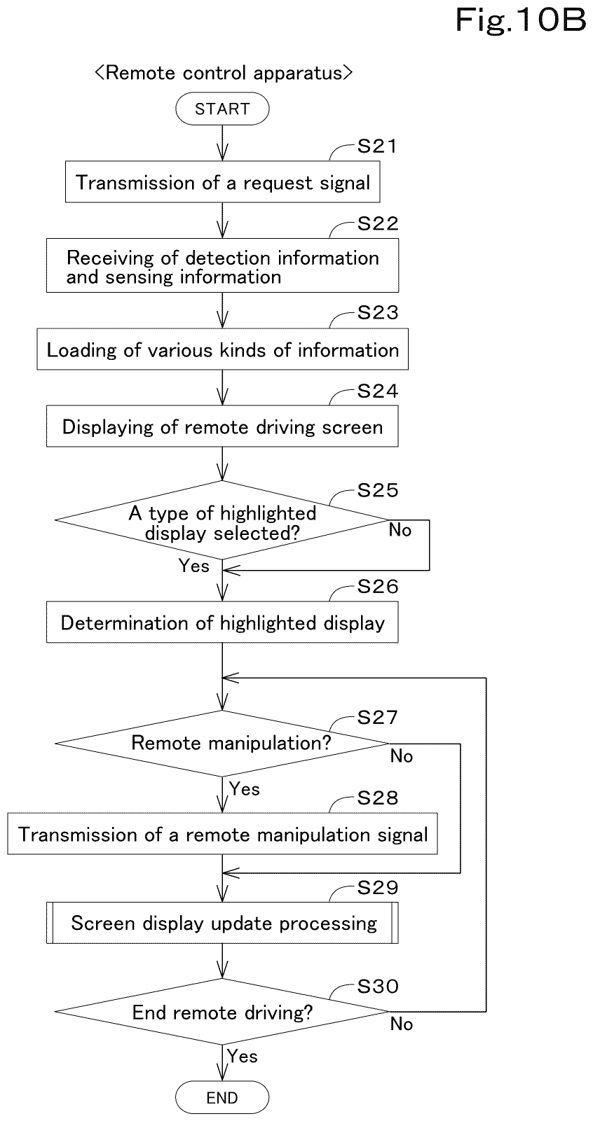

With reference to FIGS. 10A and 10B, processing for performing vehicle-speed-highlighted display K in a superimposed manner on the remote driving screen G2 of the display 34 in a case where the working vehicle 1 is manipulated remotely will now be described. FIG. 10A is a flowchart illustrating the operation of the working vehicle 1 under remote driving. FIG. 10B is a flowchart illustrating the operation of the remote control apparatus 30 when the working vehicle 1 is manipulated remotely.

When the remote operator makes a request for starting remote manipulation, as illustrated in FIG. 10B, the controller 31 causes the communication module 33 to transmit a request signal for information detected by the working vehicle 1 to the working vehicle 1 (S21).

As illustrated in FIG. 10A, upon receiving the request signal from the remote control apparatus 30 via the vehicle-mounted communication module 23 (S11), the vehicle-mounted controller 21 of the working vehicle 1 transmits the detection information of the position detector 24, the detection information of the state detector 26, and the sensing information of the sensing device 25 to the remote control apparatus 30 via the vehicle-mounted communication module 23 (S12). As described earlier, the detection information of the state detector 26 includes manipulation information about the working vehicle 1 and the working implement 2 (information including at least one of the speed of the working vehicle 1 (or the acceleration thereof), the transmission switching position of the transmission 5, the braking position of the braking device 13, or the operation position of the working implement 2).

Referring back to FIG. 10B, upon receiving the detection information of the position detector 24, the detection information of the state detector 26, and the sensing information of the sensing device 25 via the communication module 33 (S22), the controller 31 of the remote control apparatus 30 causes the storage 32 to store these kinds of information. Moreover, the controller 31 loads each of the detection information of the position detector 24, the detection information of the state detector 26, the sensing information of the sensing device 25, device information showing the specifications of the working vehicle 1 and the working implement 2, and map information on the neighborhood of the working vehicle 1, which are stored in the storage 32, into the internal memory 32a (S23).

The communication module 33 receives device information showing the specifications of the working vehicle 1 and the working implement 2, and puts it into the storage 32. In addition, map information of a geographical area where the working vehicle 1 is located has been stored in the storage 32 in advance. In the step S23, the controller 31 extracts the position of the working vehicle 1 from the detection information of the position detector 24, regards an area range that is within a predetermined distance from the position of the working vehicle 1 as the neighborhood of the working vehicle 1, and loads the map information of this area range out of the storage 32 into the internal memory 32a. As another example, in the step S23, the controller 31 may receive map information of an area range that is within a predetermined distance from the position of the working vehicle 1 via the communication module 33 from an external server via the Internet or the like and read the received map information.

Then, the controller 31 causes the display 34 to display the remote driving screen G2 based on the detection information of the position detector 24, the detection information of the state detector 26, the sensing information of the sensing device 25, the device information, and the map information (S24).

The controller 31 determines whether a type of the highlighted display K is selected or not (S25). For example, in a case where an instruction for selecting a type of the highlighted display K is given by the remote operator on the selection screen G1 illustrated in FIGS. 9A to 9C (S25: Yes), the controller 31 determines that the selected type of the highlighted display K should be set (S26). On the other hand, in a case where no instruction for selecting a type of the highlighted display K is given by the remote operator (S25: No), the controller 31 determines that either the default type of the highlighted display K or the type of the highlighted display K that was set last time should be set (S26).

It is assumed in this example that, in S26, as illustrated in FIG. 9A, the controller 31 determines that the type that should be set is the highlighted display K of the first display mode illustrated in FIG. 5B (center line (broken line)).

The controller 31 determines whether there is a manipulating operation performed via the manipulator 35 or not (S27). If there is a manipulating operation performed via the manipulator 35 (S27: Yes), the controller 31 causes the communication module 33 to transmit a remote manipulation signal corresponding to the manipulating operation performed via the manipulator 35 to the working vehicle 1 (S28). For example, a remote manipulation signal that includes various kinds of operation signal corresponding to the operation of the handle 35a, the accelerator pedal 35b, the brake pedal 35c, and the transmission shift lever 35d by the remote operator is transmitted from the remote control apparatus 30 to the working vehicle 1.

Referring back to FIG. 10A, after S12, the vehicle-mounted controller 21 determines whether there is a remote manipulation signal sent from the remote control apparatus 30 or not (S13). In a case where the vehicle-mounted controller 21 receives a remote manipulation signal sent from the remote control apparatus 30 via the vehicle-mounted communication module 23 (S13: Yes), the vehicle-mounted controller 21 controls the traveling of the working vehicle 1, work performed by the working implement 2, and other operations of the working vehicle 1 based on the sensing information of the sensing device 25, the detection information of the state detector 26, the detection information of the position detector 24, and the remote manipulation signal (S14).

The working vehicle 1 operates in accordance with the remote manipulation signal sent from the remote control apparatus 30. That is, the vehicle-mounted controller 21 causes the steering wheel 11a (FIG. 2), the accelerator pedal, the brake pedal, and the transmission shift lever 11d, etc., of the manipulator 11 to operate in accordance with various kinds of operation signal corresponding to the operation of the handle 35a, the accelerator pedal 35b, the brake pedal 35c, and the transmission shift lever 35d, etc., by the remote operator.

On the other hand, after S28, or in a case where there is no manipulating operation performed via the manipulator 35 (S27: No), the controller 31 of the remote control apparatus 30 advances the process to screen display update processing (S29).

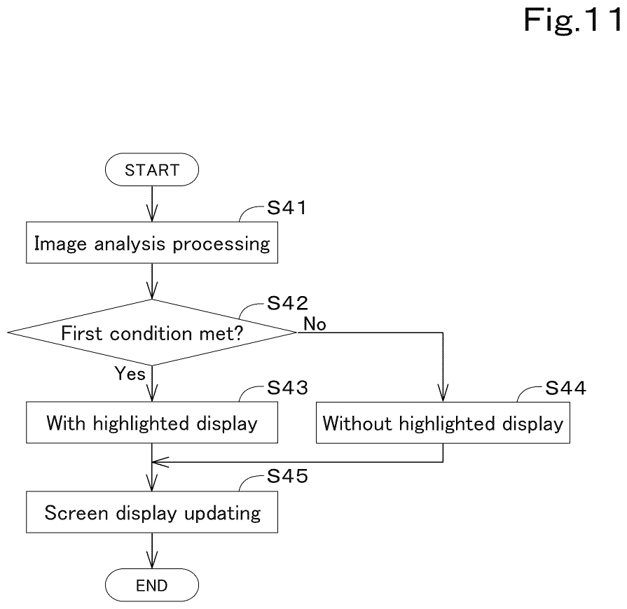

The controller 31 performs screen display update processing (S29). That is, each time correspondence data is received from the working vehicle 1 when remote driving is being performed, the controller 31 performs the screen display update processing. FIG. 11 is a flowchart illustrating the screen display update processing. The controller 31 performs image analysis processing (S41).

Specifically, the communication module 33 of the remote control apparatus 30 receives pieces of the detection information of the position detector 24, the detection information of the state detector 26, and the sensing information of the sensing device 25 from the working vehicle 1 one after another. The communication module 33 receives pieces of correspondence data included in the pieces of the detection information (that is, correspondence data in which the image captured by the internal camera 25c1, the traveling information of the working vehicle 1 detected by the state detector 26, and the position information of the working vehicle 1 detected by the position detector 24 are associated to correspond to one another) one after another.

The controller 31 performs image analysis processing on each captured image received one after another (the image captured by the internal camera 25c1) (S41). The controller 31 determines whether any road-surface marking is included in the captured image or not by performing known image analysis processing (for example, pattern matching processing). The controller 31 determines whether the first condition is met or not (S42). The controller 31 determines that the first condition is met (S42: Yes) in a case where no road-surface marking is included in the captured image, and thus determines that screen display should be performed with highlighted display (S43). On the other hand, the controller 31 determines that the first condition is not met (S42: No) in a case where a road-surface marking is included in the captured image, and thus determines that screen display should be performed without highlighted display (S44).

The controller 31 may determine whether or not an amount of change between a plurality of captured images is not less than a threshold value by performing known difference image processing in S41. The controller 31 determines that the first condition is met (S42: Yes) in a case where the amount of change between the plurality of captured images is less than the threshold value, and thus determines that screen display should be performed with highlighted display (S43). On the other hand, the controller 31 determines that the first condition is not met (S42: No) in a case where the amount of change between the plurality of captured images is not less than the threshold value, and thus determines that screen display should be performed without highlighted display (S44).

The controller 31 performs screen display updating (S45). Specifically, the controller 31 updates the captured image that is to be displayed on the remote driving screen G2 into the captured image included in the correspondence data received by the communication module 33 and, if the first condition is met (S42: Yes), commands that the highlighted display K should be performed in a superimposed manner on the captured image. Since it has been determined in S26 described earlier that the type is the highlighted display K of the first display mode, as illustrated in FIG. 5B, the controller 31 commands that the highlighted display K of the first display mode (center line (broken line)) should be performed in a superimposed manner.

On the other hand, the controller 31 updates the captured image that is to be displayed on the remote driving screen G2 into the captured image included in the correspondence data received by the communication module 33 and, if the first condition is not met (S42: No), commands that the highlighted display K should not be performed in a superimposed manner on the captured image. Consequently, the remote driving screen G2 without the highlighted display K is displayed.

Referring back to FIG. 10A, the vehicle-mounted controller 21 presets an area that is within a preset distance in the traveling direction of the working vehicle 1 from the working vehicle 1 as an emergency stop area. Therefore, when the working vehicle 1 is traveling under remote operation by the remote control apparatus 30, upon detecting the entry of an obstacle into the emergency stop area, the vehicle-mounted controller 21 issues a command for an emergency stop of the traveling of the working vehicle 1 automatically based on the sensing information of the sensing device 25 in order to prevent a collision of the working vehicle 1 with the obstacle (S15: YES). Then, the process returns to S12.

On the other hand, in a case where the entry of an obstacle into the emergency stop area is not detected (S15: No), that is, if there is no obstacle in the emergency stop area, the vehicle-mounted controller 21 determines whether to terminate the remote driving or not (S16). For example, the vehicle-mounted controller 21 terminates the remote driving if an end signal for terminating the remote driving is received from the remote control apparatus 30 (S16: Yes). If an end signal for terminating the remote driving is not received from the remote control apparatus 30 (S16: No), the vehicle-mounted controller 21 returns the process to S12.

Referring back to FIG. 10B, the controller 31 determines whether to terminate the remote driving or not (S30). For example, if no instruction for terminating the remote driving is given by the remote operator (S30: No), the controller 31 returns the process to S27. If instructed to terminate the remote driving (S30: Yes), the controller 31 terminates the remote driving.

In the example embodiment described above, the highlighted display K is performed in a superimposed manner on the remote driving screen G2 if it is determined that the first condition is met when the working vehicle 1 travels inside an agricultural field under remote driving; however, the scope of the disclosure is not limited to this example. For example, the highlighted display K may be performed in a superimposed manner on the remote driving screen G2 if it is determined that the first condition is met when the working vehicle 1 is driven remotely for movement between agricultural fields, movement between an agricultural field and a barn, movement on a farm road or an ordinary road, or the like.

The remote control apparatus 30 according to the present example embodiment described above includes a manipulator 35 to manipulate a working vehicle 1 remotely, a communication module 33 configured or programmed to receive traveling information that indicates a speed of the working vehicle 1, a display 34, and a controller 31 configured or programmed to cause the display 34 to perform vehicle-speed-highlighted display K that changes in accordance with the speed of the working vehicle 1 indicated by the traveling information when the working vehicle 1 is driven remotely via the manipulator 35. According to this configuration, the highlighted display K that changes in accordance with the speed of the working vehicle 1 (that is, the vehicle-speed-highlighted display K) is performed when the working vehicle 1 is driven remotely. The highlighted display K makes it easier for the remote operator to feel the speed of the working vehicle 1 by physical perception. That is, it is possible to make the remote operator conscious of the speed of the working vehicle 1. Because the remote operator is more aware of the speed (or acceleration) of the working vehicle 1, the remote operator can remotely operate the working vehicle 1 more appropriately, in particular more safely, e.g., with the manipulator 35.

The communication module 33 is configured or programmed to receive captured images one after another when the working vehicle 1 is driven remotely, the captured images being obtained by performing imaging in a traveling direction of the working vehicle 1, the display 34 is configured to display the captured images on a remote driving screen G2 one after another, and the controller 31 is configured or programmed to command that the highlighted display K be performed on the remote driving screen G2. With this configuration, since the highlighted display K is performed on the remote driving screen G2 on which the captured images obtained by performing imaging in the traveling direction of the working vehicle 1 are displayed one after another, it is possible to impart a sense of the speed of the working vehicle 1 to the captured image on the remote driving screen G2 and thus make it easier to feel the speed of the working vehicle 1 by physical perception on the remote driving screen G2.

The controller 31 is configured or programmed to command that the highlighted display K be performed on the remote driving screen G2 when a first condition is met, and command that the highlighted display K be not performed on the remote driving screen G2 when the first condition is not met. With this configuration, it is possible to perform switching appropriately as to whether or not to perform the highlighted display K on the remote driving screen G2. That is, it is possible to perform switching appropriately as to whether or not to provide a sense of the speed of the working vehicle 1 to the remote operator, so that the remote operator can remotely operate the working vehicle 1 more appropriately without being overloaded with information when unnecessary.

The controller 31 is configured or programmed to determine that the first condition is met in a case where an amount of change between a plurality of captured images is less than a threshold value, and determine that the first condition is not met in a case where the amount of change between the plurality of captured images is not less than the threshold value. With this configuration, in a case where an amount of change between a plurality of captured images is less than a threshold value, it is possible to determine that the area where the working vehicle 1 is traveling under remote driving is an area that is poor in changes in ambient scenery. For example, a pastureland, a field, or the like is a land whose ground color is substantially the same; moreover, due to the lack of a center line and the like, this kind of area (land) is poor in changes in color. Such an area that is poor in changes in ambient scenery (for example, a pastureland, a field, or the like) makes the vehicle speed harder to feel by physical perception. Addressing this problem, the highlighted display K is performed in an area that is poor in changes in ambient scenery. Therefore, it is easier for the remote operator to feel the speed of the working vehicle 1 by physical perception in an area that is poor in changes in ambient scenery. That is, it is possible to make the remote operator conscious of the speed of the working vehicle 1 when performing remote manipulation for a location where it is difficult to feel the speed of the working vehicle 1 by physical perception. On the other hand, in a case where the amount of change between the plurality of captured images is not less than the threshold value, it is possible to determine that the area where the working vehicle 1 is traveling under remote driving is an area that is rich in changes in ambient scenery. Since it is easier to feel the speed of the working vehicle 1 by physical perception in an area that is rich in changes in ambient scenery than in an area that is poor in changes in ambient scenery, the highlighted display K is not performed.

Moreover, the controller 31 is configured or programmed to determine that the first condition is met in a case where no road-surface marking is included in the captured image, and determine that the first condition is not met in a case where a road-surface marking is included in the captured image. With this configuration, in a case where no road-surface marking (for example, markings on the surface of a road (markings for traffic instructions such as a center line, a borderline between traffic lanes, regulatory markings such as traffic regulation marks)) is included in the captured image, it is possible to determine that the area where the working vehicle 1 is traveling under remote driving is an area that is poor in changes in ambient scenery (for example, a pastureland, a field, or the like). The highlighted display K is performed in an area that is poor in changes in ambient scenery. Therefore, it is easier for the remote operator to feel the speed of the working vehicle 1 by physical perception in an area that is poor in changes in ambient scenery. On the other hand, in a case where a road-surface marking is included in the captured image, it is possible to determine that the area where the working vehicle 1 is traveling under remote driving is an area that is rich in changes in ambient scenery (for example, an ordinary road). Since it is easier to feel the speed of the working vehicle 1 by physical perception in an area that is rich in changes in ambient scenery than in an area that is poor in changes in ambient scenery, the highlighted display K is not performed.

As the highlighted display K, the controller 31 is configured or programmed to command that a sign K1 extending in the traveling direction of the working vehicle 1 be displayed in a superimposed manner on the captured image on the remote driving screen G2, and, in addition, command that a moving display speed of the sign K1 be changed in accordance with the speed of the working vehicle 1. According to this configuration, as the highlighted display K, the controller 31 is configured or programmed to command that a sign K1 (for example, a center line, a “between-lanes” borderline, or the like) in the traveling direction of the working vehicle 1 be displayed in a superimposed manner on the captured image on the remote driving screen G2, and, in addition, command that a moving display speed of the sign K1 be changed in accordance with the speed of the working vehicle 1. That is, it is possible to highlight the vehicle speed by increasing the moving display speed of the sign K1. Since the sign K1 the moving display speed of which is changed in accordance with the speed of the working vehicle 1 is displayed in a superimposed manner on the captured image on the remote driving screen G2, it is possible to impart a sense of the speed of the working vehicle 1 to the captured image on the remote driving screen G2 and thus make it easier to feel the speed of the working vehicle 1 by physical perception on the remote driving screen G2.

As the highlighted display K, the controller 31 is configured or programmed to command that a sign K1, K2 extending in the traveling direction of the working vehicle 1 be displayed in a superimposed manner on the captured image on the remote driving screen G2, and, in addition, command that a color of the sign K1, K2 be varied in accordance with the speed of the working vehicle 1. According to this configuration, as the highlighted display K, the controller 31 commands that a sign K1, K2 (for example, a center line, a “between-lanes” borderline, or the like) in the traveling direction of the working vehicle 1 be displayed in a superimposed manner on the captured image on the remote driving screen G2 and, in addition, commands that a color of the sign K1, K2 be varied in accordance with the speed of the working vehicle 1. That is, it is possible to highlight the vehicle speed by varying the color of the sign K1, K2. Since the sign K1, K2 the color of which is varied in accordance with the speed of the working vehicle 1 is displayed in a superimposed manner on the captured image on the remote driving screen G2, it is possible to impart a sense of the speed of the working vehicle 1 to the captured image on the remote driving screen G2 and thus make it easier to feel the speed of the working vehicle 1 by physical perception on the remote driving screen G2.

As the highlighted display K, the controller 31 is configured or programmed to command that a plurality of virtual signs Kc arranged along the traveling direction of the working vehicle 1 be displayed in a superimposed manner on the captured image on the remote driving screen G2, and, in addition, command that the moving display speed of the plurality of virtual signs Kc be changed in accordance with the speed of the working vehicle 1. According to this configuration, as the highlighted display K, the controller 31 is configured or programmed to command that a plurality of virtual signs Kc (for example, road cones or the like) arranged along the traveling direction of the working vehicle 1 be displayed in a superimposed manner on the captured image on the remote driving screen G2, and, in addition, command that the moving display speed of the plurality of virtual signs Kc be changed in accordance with the speed of the working vehicle 1. That is, it is possible to highlight the vehicle speed by increasing the moving display speed of the plurality of virtual signs Kc. Since the plurality of virtual signs Kc the moving display speed of which is changed in accordance with the speed of the working vehicle 1 is displayed in a superimposed manner on the captured image on the remote driving screen G2, it is possible to impart a sense of the speed of the working vehicle 1 to the captured image on the remote driving screen G2 and thus make it easier to feel the speed of the working vehicle 1 by physical perception on the remote driving screen G2.

As the highlighted display K, the controller 31 is configured or programmed to command that an acceleration-effects rendering area K4, K5 be displayed on a peripheral portion PP of the remote driving screen G2 in accordance with the speed or acceleration of the working vehicle 1. According to this configuration, as the highlighted display K, the controller 31 is configured or programmed to command that an acceleration-effects rendering area K4, K5 be displayed on a peripheral portion PP of the remote driving screen G2 in accordance with the speed or acceleration of the working vehicle 1. That is, it is possible to highlight the vehicle speed via the acceleration-effects rendering area K4, K5 displayed on the peripheral portion PP of the remote driving screen G2.

The controller 31 is configured or programmed to command that the acceleration-effects rendering area K4, K5 be displayed with an increase in size as the speed or acceleration of the working vehicle 1 increases. According to this configuration, since the acceleration-effects rendering area K4, K5 displayed on the peripheral portion PP of the remote driving screen G2 is displayed with an increase in size as the speed or acceleration of the working vehicle 1 increases, the size of the captured image on the remote driving screen G2 decreases. Therefore, it is possible to produce such display effects that make the field of view narrower as the speed or acceleration of the working vehicle 1 increases. This makes it possible to impart a sense of the speed of the working vehicle 1 to the captured image on the remote driving screen G2 much more and thus make it easier to feel the speed of the working vehicle 1 much more by physical perception on the remote driving screen G2.

As the highlighted display K, the controller 31 is configured or programmed to command that the color of the entire remote driving screen G2 be varied in accordance with the speed or acceleration of the working vehicle 1. According to this configuration, as the highlighted display K, the controller 31 is configured or programmed to command that the color of the entire remote driving screen G2 be varied in accordance with the speed or acceleration of the working vehicle 1. That is, since the color of the entire remote driving screen G2 is varied in accordance with the speed or acceleration of the working vehicle 1, it is possible to highlight the vehicle speed, or the acceleration.

As the highlighted display K, the controller 31 is configured or programmed to command that the color of a frame F of the remote driving screen G2 be varied in accordance with the speed or acceleration of the working vehicle 1. According to this configuration, as the highlighted display K, the controller 31 is configured or programmed to command that the color of the frame F of the remote driving screen G2 be varied in accordance with the speed or acceleration of the working vehicle 1. That is, since the color of the frame F of the remote driving screen G2 is varied in accordance with the speed or acceleration of the working vehicle 1, it is possible to highlight the vehicle speed, or the acceleration.

When the working vehicle 1 is traveling rearward, the controller 31 is configured or programmed to command that an image captured at a time of rearward traveling of the working vehicle 1 be displayed on the remote driving screen G2, and command that, as the highlighted display K, a mode of a guide line K6 displayed on the remote driving screen G2 be varied in accordance with the speed or acceleration of the working vehicle 1. According to this configuration, as the highlighted display K, the controller 31 is configured or programmed to command that the mode of the guide line (an anticipated course of traveling, a parking guide line, or the like) displayed on the remote driving screen G2 be varied in accordance with the speed or acceleration of the working vehicle 1. That is, since the mode of the guide line displayed on the remote driving screen G2 is varied in accordance with the speed or acceleration of the working vehicle 1, it is possible to highlight the vehicle speed, or the acceleration.

A remote manipulation system 100 includes a working vehicle 1, and a remote control apparatus 30. The working vehicle 1 includes a detector (the state detector 26) to detect a speed or an acceleration of the working vehicle 1, an imager (the camera 25c) to perform imaging in a traveling direction of the working vehicle 1, and a vehicle-mounted communication module 23 configured or programmed to transmit correspondence data in which traveling information indicating the speed or acceleration detected by the state detector 26 and a captured image obtained by the camera 25c are associated to correspond to each other, wherein a communication module 33 of the remote control apparatus 30 is configured or programmed to receive the correspondence data transmitted from the vehicle-mounted communication module 23. According to this configuration, when remote driving of the working vehicle 1 is performed by manipulating the working vehicle 1 remotely via a manipulator 35 of the remote control apparatus 30, highlighted display K that changes in accordance with the speed of the working vehicle 1 (that is, vehicle-speed-highlighted display K) is performed on a display 34 of the remote control apparatus 30. The highlighted display K makes it easier for the remote operator to feel the speed of the working vehicle 1 by physical perception. That is, it is possible to make the remote operator conscious of the speed of the working vehicle 1.

### First Modification Example

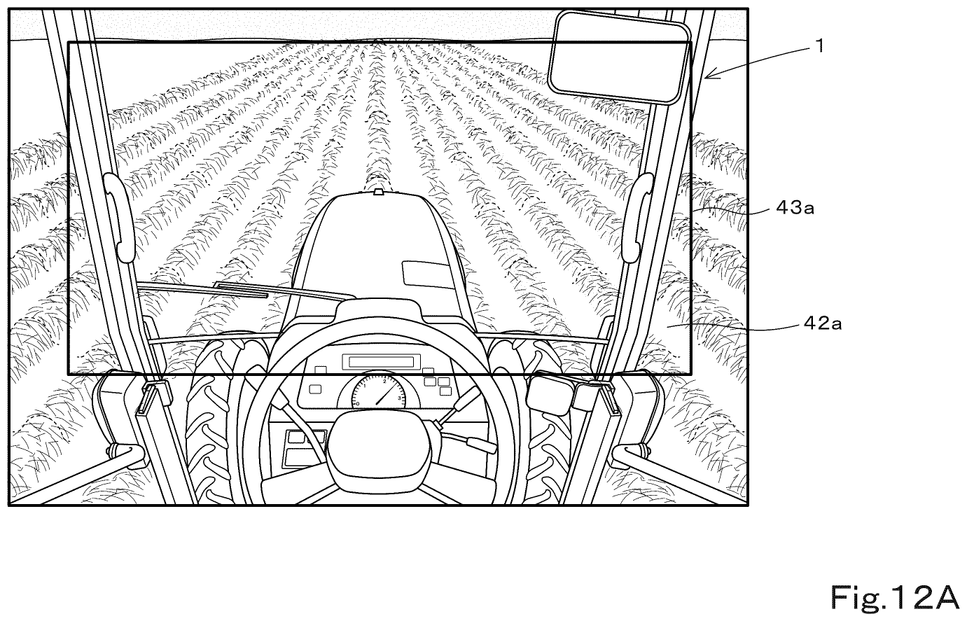

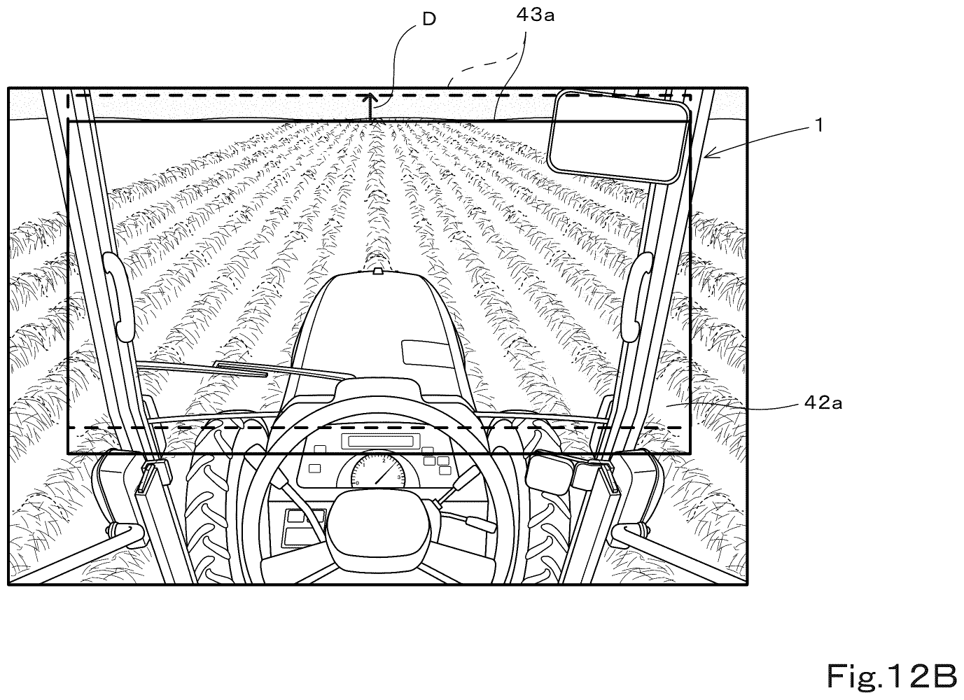

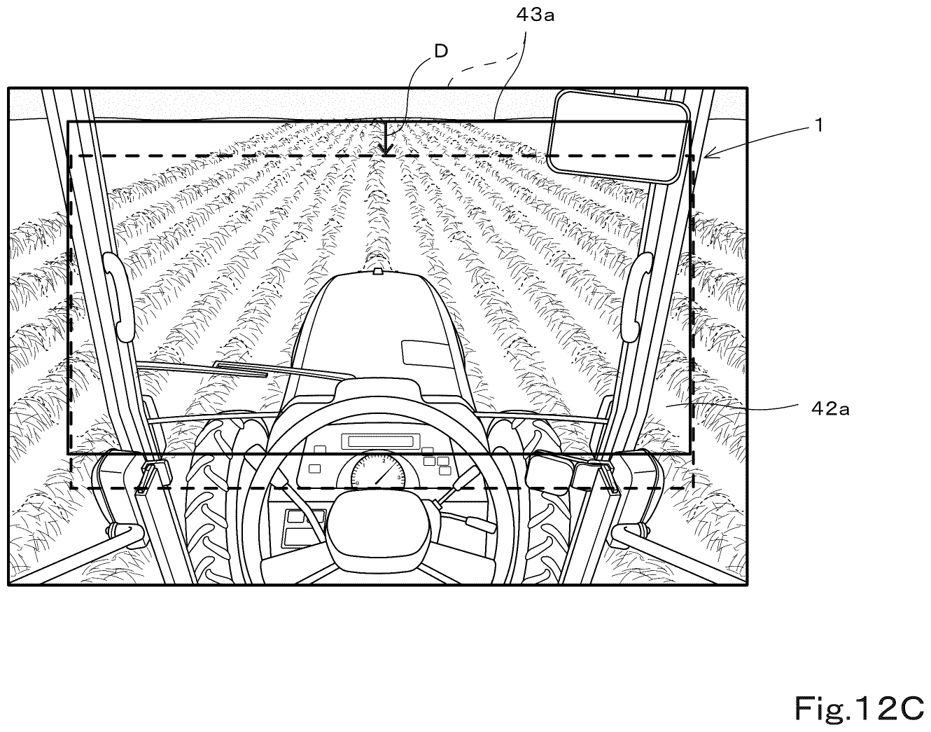

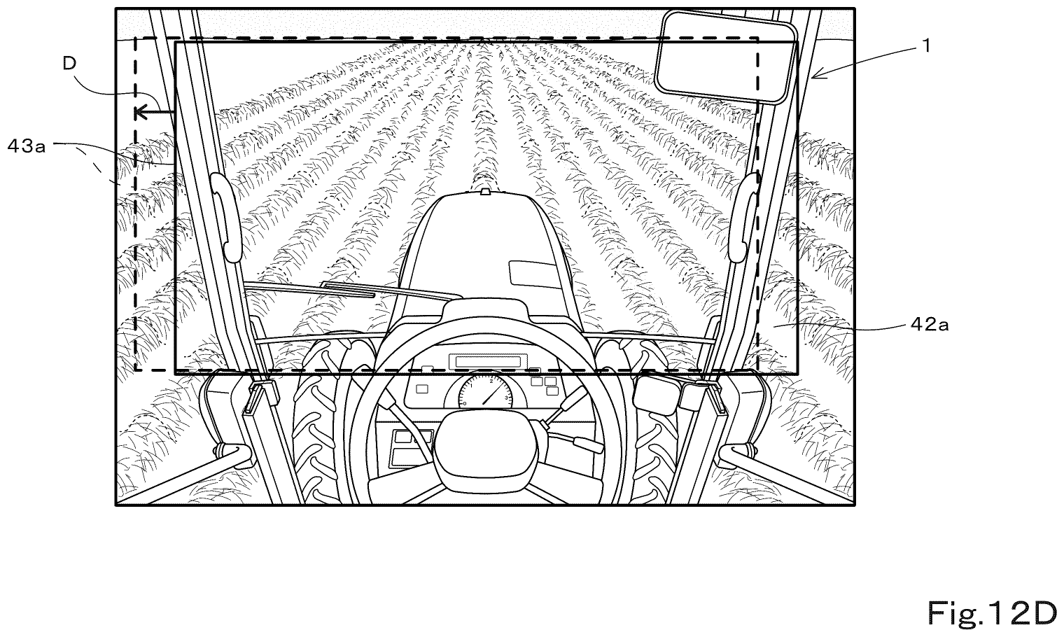

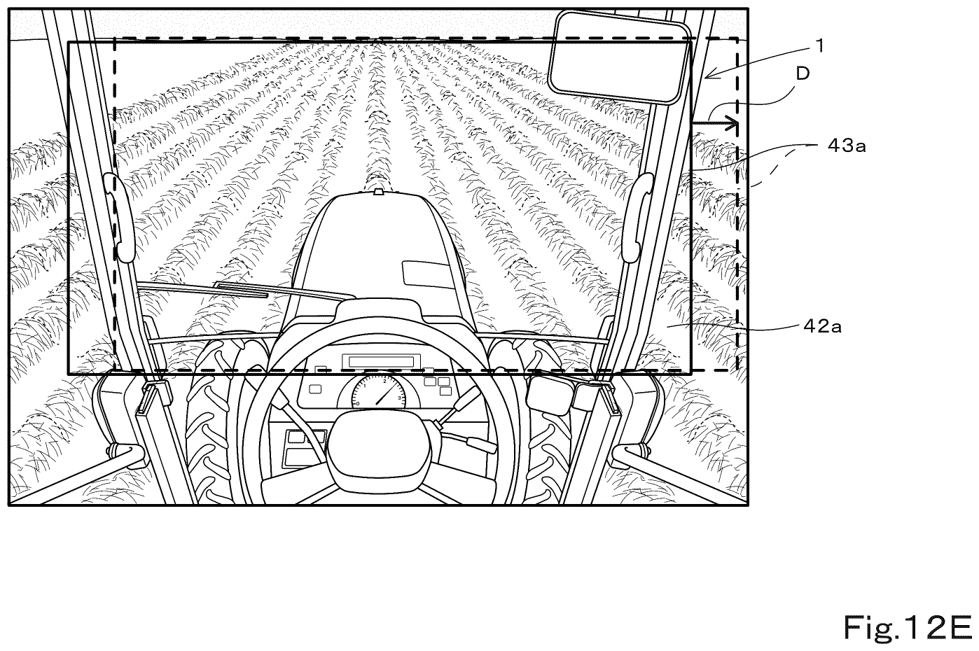

In the remote control apparatus 30 and the remote manipulation system 100 according to a first modification of an example embodiment of the present invention, as illustrated in FIGS. 12A to 12E, the controller 31 is configured or programmed to command that, if the working vehicle 1 accelerates or decelerates or is steered abruptly during remote operation of the working vehicle 1, such highlighted display K that changes a range that is displayed as a captured image should be performed on the remote driving screen G2. FIG. 12A is a diagram illustrating an example of the remote driving screen G2 according to the first modification example. Each of FIGS. 12B to 12E is a diagram illustrating the highlighted display K of the eighth display mode on the remote driving screen G2 according to the first modification of an example embodiment of the present invention.

As illustrated in FIG. 12A, a range that is displayed as a captured image (that is, a range to be displayed in the window 43a), of the captured image obtained by the camera 25c, has been determined in advance. For example, the range that is displayed as a captured image is a rectangular range the center point of which lies on the center line of the direction in which the camera 25c is aimed at (the imaging direction).

As illustrated in FIG. 12B, when the working vehicle 1 is accelerating, the controller 31 commands that the range that is displayed as a captured image on the remote driving screen G2 should be shifted up by a distance D that corresponds to a change in acceleration. For example, in a case where the working vehicle 1 accelerates more than a predetermined value, the controller 31 commands that the range that is displayed as a captured image on the remote driving screen G2 should be shifted up by a distance D that corresponds to a change in acceleration. That is, the captured image is displayed in such a manner as if the camera were tilting up. On the other hand, in a case where the working vehicle 1 accelerates less than the predetermined value, the controller 31 commands that the range that is displayed as a captured image on the remote driving screen G2 should not be shifted. As described above, the highlighted display K illustrated in FIG. 12B is performed in a case of aggressive acceleration (acceleration more than the predetermined value), whereas the remote driving screen G2 illustrated in FIG. 12A is displayed without performing the highlighted display K illustrated in FIG. 12B in a case of gentle acceleration (acceleration less than the predetermined value).

As illustrated in FIG. 12C, when the working vehicle 1 is decelerating, the controller 31 commands that the range that is displayed as a captured image on the remote driving screen G2 should be shifted down by a distance D that corresponds to a change in acceleration. For example, in a case where the working vehicle 1 decelerates more than a predetermined value, the controller 31 commands that the range that is displayed as a captured image on the remote driving screen G2 should be shifted down by a distance D that corresponds to a change in acceleration. That is, the captured image is displayed in such a manner as if the camera were tilting down. On the other hand, in a case where the working vehicle 1 decelerates less than the predetermined value, the controller 31 commands that the range that is displayed as a captured image on the remote driving screen G2 should not be shifted. As described above, the highlighted display K illustrated in FIG. 12C is performed in a case of aggressive deceleration (deceleration more than the predetermined value), whereas the remote driving screen G2 illustrated in FIG. 12A is displayed without performing the highlighted display K illustrated in FIG. 12C in a case of gentle deceleration (deceleration less than the predetermined value).

As illustrated in FIG. 12E, when the working vehicle 1 is being steered leftward, the controller 31 commands that the range that is displayed as a captured image on the remote driving screen G2 should be shifted to the right by a distance D that corresponds to a leftward steering angle. For example, the controller 31 commands that the range that is displayed as a captured image on the remote driving screen G2 should be shifted to the right by the distance D that corresponds to the leftward steering angle in a case where the leftward steering angle of the working vehicle 1 is not less than a predetermined value, and commands that the range that is displayed as a captured image on the remote driving screen G2 should not be shifted in a case where the leftward steering angle of the working vehicle 1 is less than the predetermined value. As described above, the highlighted display K illustrated in FIG. 12E is performed in a case of abrupt steering to the left, whereas the remote driving screen G2 illustrated in FIG. 12A is displayed without performing the highlighted display K illustrated in FIG. 12E in a case of gentle steering to the left.

As illustrated in FIG. 12D, when the working vehicle 1 is being steered rightward, the controller 31 commands that the range that is displayed as a captured image on the remote driving screen G2 should be shifted to the left by a distance D that corresponds to a rightward steering angle. For example, the controller 31 commands that the range that is displayed as a captured image on the remote driving screen G2 should be shifted to the left by the distance D that corresponds to the rightward steering angle in a case where the rightward steering angle of the working vehicle 1 is not less than a predetermined value, and commands that the range that is displayed as a captured image on the remote driving screen G2 should not be shifted in a case where the rightward steering angle of the working vehicle 1 is less than the predetermined value. As described above, the highlighted display K illustrated in FIG. 12D is performed in a case of abrupt steering to the right, whereas the remote driving screen G2 illustrated in FIG. 12A is displayed without performing the highlighted display K illustrated in FIG. 12D in a case of gentle steering to the right.

Instead of changing the range that is displayed as a captured image, of the captured image obtained by the camera 25c as described above, the range of imaging by the camera 25c (that is, the orientation of the camera 25c) may be changed. Specifically, when a sharp change in speed of the working vehicle 1 (for example, a change in acceleration more than a predetermined value) is detected by the state detector 26 of the working vehicle 1, the mount angle of the camera 25c on the working vehicle 1 is changed by performing automatic control by the vehicle-mounted controller 21 of the working vehicle 1. For example, in a case where aggressive acceleration is detected by the state detector 26, the vehicle-mounted controller 21 may be configured or programmed to perform control such that the mount angle of the camera 25c will be adjusted up by an angle corresponding to a change in acceleration and thus that the imaging orientation of the camera 25c will be shifted upward. Similar control may be performed in a case of aggressive deceleration, a sharp turn to the left, and a sharp turn to the right. That is, the vehicle-mounted controller 21 may perform control such that the mount angle of the camera 25c will be adjusted down, to the left, or to the right by an angle corresponding to a change in acceleration and thus that the imaging orientation of the camera 25c will be shifted down, to the left, or to the right.

The controller 31 is configured or programmed to determine whether or not to perform the highlighted display K of the eighth display mode illustrated in FIGS. 12B to 12E in accordance with a selection operation performed by the remote operator on a selection screen G1 illustrated in FIG. 9D. FIG. 9D is a diagram illustrating an example of a selection screen G1 according to the first modification example on the display 34.

Specifically, when a predetermined adding instruction, for example, a setting instruction for additional effects (feeling-effect-adding rendering), is given by the remote operator, the controller 31 causes the display 34 to display a selection screen G1 as illustrated in FIG. 9D. On the selection screen G1 illustrated in FIG. 9D, an individual ON/OFF setting can be made for each of three rendering items that constitute feeling-effect-adding rendering. The three rendering items include a camera-tilting-up effect rendering in a case of aggressive acceleration, a camera-tilting-down effect rendering in a case of aggressive deceleration, and a camera-panning-to-the-left/right effect rendering in a case of abrupt steering. In FIG. 9D, all of these three rendering items are set to be ON.

In a case where the first condition illustrated in FIG. 11 is met (S42: Yes), the controller 31 commands that the highlighted display K (feeling-effect-adding rendering) illustrated in FIG. 12B should be performed in a case of aggressive acceleration of the working vehicle 1 (acceleration more than the predetermined value), commands that the highlighted display K (feeling-effect-adding rendering) illustrated in FIG. 12C should be performed in a case of aggressive deceleration of the working vehicle 1 (deceleration more than the predetermined value), and commands that the highlighted display K (feeling-effect-adding rendering) illustrated in FIG. 12D, 12E should be performed in a case of abrupt steering (the steering angle not less than the predetermined value). The controller 31 may command that the highlighted display K (feeling-effect-adding rendering) illustrated in FIG. 12B to 12E should be performed in addition to the highlighted display K illustrated in FIG. 5B, 5C, 6, 7A, 7B, 8A, 8B, 8C.

In the remote control apparatus 30 according to the first modification of an example embodiment of the present invention, the controller 31 commands that the display position of the captured image on the remote driving screen G2 should be shifted up by a distance D that corresponds to a change in acceleration when the working vehicle 1 is accelerating, and commands that the display position of the captured image on the remote driving screen G2 should be shifted down by a distance D that corresponds to a change in acceleration when the working vehicle 1 is decelerating. With this configuration, since the display position of the captured image on the remote driving screen G2 is shifted up by the distance D that corresponds to the change in acceleration when the working vehicle 1 is accelerating, it is possible to render an effect producing a sense of acceleration to the remote operator. Moreover, since the display position of the captured image on the remote driving screen G2 is shifted down by the distance D that corresponds to the change in acceleration when the working vehicle 1 is decelerating, it is possible to render an effect producing a sense of deceleration to the remote operator.

The controller 31 commands that the display position of the captured image on the remote driving screen G2 should be shifted to the right by a distance D that corresponds to a leftward steering angle when the working vehicle 1 is being steered leftward, and commands that the display position of the captured image on the remote driving screen G2 should be shifted to the left by a distance D that corresponds to a rightward steering angle when the working vehicle 1 is being steered rightward. With this configuration, since the display position of the captured image on the remote driving screen G2 is shifted to the right by the distance D that corresponds to the leftward steering angle when the working vehicle 1 is being steered leftward, it is possible to render an effect producing a sense of making a sharp turn to the left to the remote operator. Moreover, since the display position of the captured image on the remote driving screen G2 is shifted to the left by the distance D that corresponds to the rightward steering angle when the working vehicle 1 is being steered rightward, it is possible to render an effect producing a sense of making a sharp turn to the right to the remote operator.

### Second Modification Example

In the remote control apparatus 30 and the remote manipulation system 100 according to the foregoing example embodiments, the controller 31 is configured or programmed to determine whether the first condition is met or not based on captured images. However, the basis for the determination is not limited to this example. The remote control apparatus 30 and the remote manipulation system 100 according to a second modification of an example embodiment of the present invention are configured or programmed to determine whether the first condition is met or not based on map information.

For example, with the use of the position information of the working vehicle 1 and map information, the controller 31 according to the second modification of an example embodiment of the present invention determines that the first condition is met if the current position indicated by the position information of the working vehicle 1 is within a predetermined area (for example, the agricultural field H1) on a map indicated by the map information, and determines that the first condition is not met if not within the predetermined area (for example, the agricultural field H1).

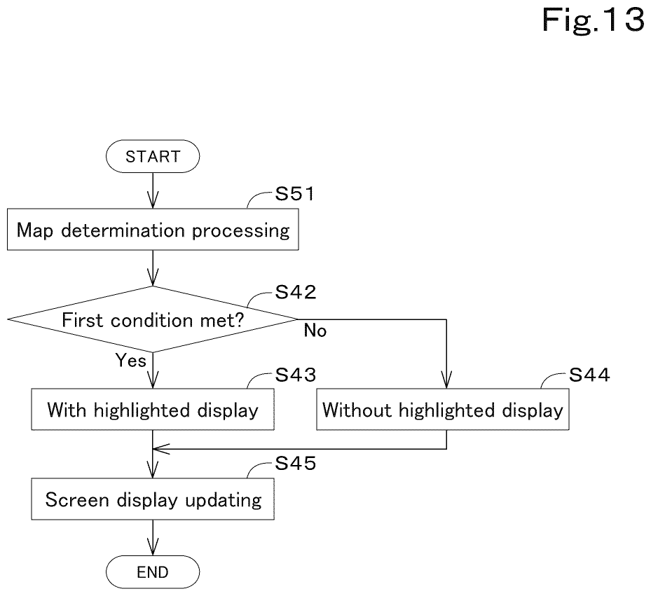

FIG. 13 is a flowchart illustrating screen display update processing according to the second modification of an example embodiment of the present invention. The controller 31 is configured or programmed to perform map determination processing (S51). Specifically, for example, map information that includes the agricultural field H1 is pre-stored in the storage 32. In the map determination processing (S51), the controller 31 determines whether the current position indicated by the position information of the working vehicle 1 is within the predetermined area (for example, the agricultural field H1) on the map indicated by the map information or not by using the position information of the working vehicle 1 and the map information stored in the storage 32. The controller 31 determines that the first condition is met if the current position of the working vehicle 1 is within the agricultural field H1 (S42: Yes). The controller 31 determines that the first condition is not met if the current position of the working vehicle 1 is not within the agricultural field H1 (S42: No). Since S43 to S45 are the same as those of FIG. 11, an explanation of them is omitted here.

According to the second modification of an example embodiment of the present invention, with the use of the position information of the working vehicle 1 and the map information, the controller 31 determines that the first condition is met if the current position indicated by the position information of the working vehicle 1 is within the predetermined area on the map indicated by the map information, and determines that the first condition is not met if not within the predetermined area. With this configuration, since it is determined that the first condition is met if the position of the working vehicle 1 is within the predetermined area (for example, an agricultural field, a pastureland, a farm road, or the like) on the map, it is possible to determine whether the first condition is met or not simply, without any need for analyzing the captured images.

In the foregoing example embodiment and the first and second modifications of an example embodiment of the present invention, the highlighted display K is performed on the remote driving screen G2. However, the highlighted display K may be performed on a peripheral device (for example, the handle 35a or the like) of the manipulator 35 of the remote control apparatus 30 illustrated in FIG. 1.

In addition to the highlighted display K according to the foregoing example embodiments and the first and second modifications of an example embodiment of the present invention, air may be blown to the remote operator seated on the remote operator's seat, and wind strength may be changed in accordance with the traveling speed of the working vehicle 1. For example, the wind strength increases as the traveling speed of the working vehicle 1 increases.

In addition to the highlighted display K according to the foregoing example embodiments and the first and second modifications of an example embodiment of the present invention, engine noise of the working vehicle 1 may be outputted to the remote operator seated on the remote operator's seat, and the loudness or type of the engine noise may be changed in accordance with the traveling speed of the working vehicle 1. For example, the loudness of the engine noise increases as the traveling speed of the working vehicle 1 increases. Alternatively, the type of the engine noise is changed in accordance with the traveling speed of the working vehicle 1. For example, engine noise may have been stored in the storage 32 in advance, and the remote control apparatus 30 may output the engine noise from its speakers 36a such that the loudness of the engine noise increases, or the type of the engine noise changes, as the traveling speed of the working vehicle 1 increases. Engine noise picked up actually by a noise collector provided on the working vehicle 1 may be sent as sound information to the remote control apparatus 30, and the remote control apparatus 30 may output, from its speakers 36a, engine noise reproduced by a sound reproducer from the sound information received by the remote control apparatus 30.

Although example embodiments of the present invention have been described above, it shall be construed that the example embodiments disclosed herein are merely illustrative in every respect and not restrictive. The scope of the present invention is defined not by the foregoing description but by the appended claims, and all modifications within the scope of the claims and its equivalents are intended to be encompassed herein.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A remote control apparatus, comprising:
a manipulator to manipulate a working vehicle remotely;
a communication module configured or programmed to receive traveling information that indicates a speed or an acceleration of the working vehicle;
a display; and
a controller configured or programmed to cause the display to perform highlighted display that changes in accordance with the traveling information when the working vehicle is driven remotely by using the manipulator.

2. The remote control apparatus according to claim 1, wherein the highlighted display changes in accordance with the traveling information and is performed in an emphasized manner as compared to a manner in which the working vehicle is actually traveling.

3. The remote control apparatus according to claim 2, wherein the highlighted display changes in accordance with the traveling information and gives an impression that the working vehicle is traveling in a state equal to or greater than an actual state in which the working vehicle is actually traveling.

4. The remote control apparatus according to claim 3, wherein the highlighted display changes in accordance with the traveling information and gives an impression that the working vehicle is traveling at a speed or acceleration greater than an actual speed or acceleration of the working vehicle.

5. The remote control apparatus according to claim 1, wherein
the communication module is configured or programmed to receive captured images one after another when the working vehicle is driven remotely, the captured images being obtained by performing imaging in a traveling direction of the working vehicle;
the display is configured to display the captured images on a remote driving screen one after another; and
the controller is configured or programmed to command that the highlighted display be performed on the remote driving screen.

6. The remote control apparatus according to claim 5, wherein the display is configured to perform the highlighted display on another portion of the remote driving screen in addition to or instead of a portion of the remote driving screen that displays a value or degree of an actual speed or acceleration of the working vehicle.

7. The remote control apparatus according to claim 5, wherein the controller is configured or programmed to:
command that the highlighted display be performed on the remote driving screen when a first condition is met; and
command that the highlighted display be not performed on the remote driving screen when the first condition is not met.

8. The remote control apparatus according to claim 7, wherein the controller is configured or programmed to:
determine that the first condition is met in a case where an amount of change between a plurality of the captured images is less than a threshold value; and
determine that the first condition is not met in a case where the amount of change between the plurality of the captured images is not less than the threshold value.

9. The remote control apparatus according to claim 7, wherein the controller is configured or programmed to:
determine that the first condition is met in a case where no road-surface marking is included in the captured image; and
determine that the first condition is not met in a case where a road-surface marking is included in the captured image.

10. The remote control apparatus according to claim 7, wherein
the controller is configured or programmed to use position information of the working vehicle and map information to:
determine that the first condition is met if a current position indicated by the position information of the working vehicle is within a predetermined area on a map indicated by the map information; and
determine that the first condition is not met if the current position indicated by the position information of the working vehicle is not within the predetermined area.

11. The remote control apparatus according to claim 5, wherein the controller is configured or programmed to command that the highlighted display be performed in a superimposed manner on the captured image on the remote driving screen.

12. The remote control apparatus according to claim 5, wherein the controller is configured or programmed to command that the highlighted display be performed on a peripheral portion of the remote driving screen or a peripheral portion of the captured image.

13. The remote control apparatus according to claim 12, wherein the controller is configured or programmed to command that a region of the peripheral portion be changed in accordance with the speed or the acceleration of the working vehicle.

14. The remote control apparatus according to claim 11, wherein the controller is configured or programmed to command that a moving speed of a sign be changed in accordance with the speed or the acceleration of the working vehicle.

15. The remote control apparatus according to claim 11, wherein the controller is configured or programmed to command that a mode of a sign be changed in accordance with the speed or the acceleration of the working vehicle.

16. The remote control apparatus according to claim 14, wherein the sign extends in the traveling direction of the working vehicle.

17. The remote control apparatus according to claim 14, wherein the sign includes a plurality of virtual signs arranged in the traveling direction of the working vehicle.

18. The remote control apparatus according to claim 5, wherein
the controller is configured or programmed to command that a color of a particular portion other than the captured image of the remote driving screen, as the highlighted display, be varied in accordance with the speed or the acceleration of the working vehicle.

19. The remote control apparatus according to claim 5, wherein
the controller is configured or programmed to command that a color of a frame of the remote driving screen, as the highlighted display, be varied in accordance with the speed or the acceleration of the working vehicle.

20. A remote manipulation system, comprising:
a working vehicle; and
the remote control apparatus according to claim 1; wherein
the working vehicle includes:
a detector to detect the speed or the acceleration of the working vehicle;
an imager to perform imaging in a traveling direction of the working vehicle; and
a vehicle-mounted communication module configured or programmed to transmit correspondence data in which the traveling information that indicates the speed or the acceleration detected by the detector and a captured image obtained by the imager are associated to correspond to each other; and
the communication module of the remote control apparatus is configured or programmed to receive the correspondence data transmitted from the vehicle-mounted communication module.
